(19) United States
(12) Patent Application Publication
(10) Pub. No.: US 2015/0074026 A1
(43) Pub. Date: Mar. 12, 2015

(54) APPARATUS AND METHODS FOR EVENT-BASED PLASTICITY IN SPIKING NEURON NETWORKS

(71) Applicant: QUALCOMM TECHNOLOGIES INC., San Diego, CA (US)

(72) Inventors: Botond Szatmary, San Diego, CA (US); Eugene Izhikevich, San Diego, CA (US)

(21) Appl. No.: 14/020,376

(22) Filed: Sep. 6, 2013

(51) Int. Cl. G06N 3/08

(52) U.S. Cl. CPC G06N 3/08
USPC 706/23; 706/25

(57) ABSTRACT

Event based communication in a spiking neuron network may be provided. The network may comprise units communicating by spikes via synapses. Responsive to a spike generation, a unit may be configured to update states of outgoing synapses. The spikes may communicate a payload data. The data may comprise one or more bits. The payload may be stored in a buffer of a pre-synaptic unit and be configured to accessed by the post-synaptic unit. Spikes of different payload may cause different actions by the recipient unit. Sensory input spikes may cause postsynaptic response and trigger connection efficacy update. Teaching input may be used to modulate plasticity.

### CROSS-REFERENCE TO RELATED APPLICATIONS

This application is related to co-owned U.S. patent application Ser. No. 13/868,944, filed Apr. 23, 2013 and entitled “APPARATUS AND METHODS FOR EVENT-BASED COMMUNICATION IN A SPIKING NEURON NETWORK”, co-owned U.S. patent application Ser. No. 13/588,774, filed Aug. 17, 2012 and entitled “APPARATUS AND METHODS FOR IMPLEMENTING EVENT-BASED UPDATES IN SPIKING NEURON NETWORK”, co-owned U.S. patent application Ser. No. 13/239,123, filed Sep. 21, 2011 and entitled “ELEMENTARY NETWORK DESCRIPTION FOR NEUROMORPHIC SYSTEMS”, co-owned U.S. patent application Ser. No. 13/239,148, filed Sep. 21, 2011 and entitled “ELEMENTARY NETWORK DESCRIPTION FOR EFFICIENT LINK BETWEEN NEURONAL MODELS AND NEUROMORPHIC SYSTEMS,” U.S. patent application Ser. No. 13/239,155, filed Sep. 21, 2011 and entitled “ELEMENTARY NETWORK DESCRIPTION FOR EFFICIENT MEMORY MANAGEMENT IN NEUROMORPHIC SYSTEMS,” U.S. patent application Ser. No. 13/239,163, filed Sep. 21, 2011 and entitled “ELEMENTARY NETWORK DESCRIPTION FOR EFFICIENT IMPLEMENTATION OF EVENT-TRIGGERED PLASTICITY RULES IN NEUROMORPHIC SYSTEMS,” U.S. patent application Ser. No. 13/239,255, filed Sep. 21, 2011 and entitled “APPARATUS AND METHODS FOR SYNAPTIC UPDATE IN A PULSE-CODED NETWORK,”, U.S. patent application Ser. No. 13/239,259, filed Sep. 21, 2011 and entitled “APPARATUS AND METHODS FOR PARTIAL EVALUATION OF SYNAPTIC UPDATES BASED ON SYSTEM EVENTS,” U.S. patent application Ser. No. 13/588,774, filed Aug. 17, 2011 and entitled “APPARATUS AND METHODS FOR IMPLEMENTING EVENT-BASED UPDATES IN SPIKING NEURON NETWORK”, each of the foregoing applications being commonly owned and incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates to parallel distributed computer systems for simulating neuronal networks that perform neural computations, such as visual perception and motor control.

2. Background

Artificial spiking neural networks may be used to process signals, to gain an understanding of biological neural networks, and for solving artificial intelligence problems. These networks typically may employ a pulse-coded mechanism, which encodes information using timing of the pulses. Such pulses (also referred to as “spikes” or ‘impulses’) are short-lasting (typically on the order of 1-2 ms) discrete temporal events.

Some existing END implementations may utilize multi-compartment neurons and/or junctions. However, junctions may require to be operated using clock-based update rules (e.g., cyclic updates). Junctions may be provided with access to pre-synaptic network parameters in order to facilitate data communication between pre-synaptic and post-synaptic sides of the junction. As a result, cyclic updates of a network with junctions may become computationally intensive.

### SUMMARY

One aspect of the disclosure relates to a computer-implemented method of operating a spiking neuron sensory input processing apparatus. The method may be performed by one or more processors configured to execute computer program modules. The method may comprise: operating, using one or more processors, the spiking neuron in accordance with a unit process characterized by an excitability; updating, using one or more processors, the excitability based on a first sensory spike received via a first connection by the neuron and a first parameter of the first connection; determining, using one or more processors, a second parameter of the neuron based on a teaching spike received via a second connection by the neuron; and responsive to a receipt of a second sensory spike via the first connection, determining the first parameter. The determination of the first parameter may be configured based on a value of the second parameter.

In some implementations, the teaching spike may occur subsequent to the first sensory spike and prior to the second sensory spike. The neuron may be configured to provide an output spike based on the excitability parameter breaching a threshold.

In some implementations, the first parameter may comprise an efficacy of the connection. The efficacy may be configured to affect the updating of the excitability responsive to receipt of the first spike. The determination of the first parameter may be configured to affect a probability of the output spike provided by the neuron.

In some implementations, the first parameter may comprise an efficacy of the connection, the efficacy being configured to affect the updating of the excitability responsive to receipt of the first spike. The determination of the first parameter may comprise an increase or decrease of the connection efficacy. The increase or the decrease may be configured to advance or delay, respectively, provision of the output spike subsequent to the second sensory spike.

In some implementations, the neuron may be characterized by a neuron memory configured to store the excitability value. The unit process may be configured to access the unit memory and to modify the excitability value. The first connection may be configured to be operable in accordance with a first connection process configured to access the first connection memory and the unit memory. The first connection memory may be configured to store the first parameter value. The second connection may be configured to be operable in accordance with a second connection process configured to access the unit memory, to effectuate the determining of the second parameter.

In some implementations, the sensory input may be configured to communicate information related to an environment external to the unit process. The sensory input may comprise the first and the second sensory spikes. The teaching spike may be configured based on a performance measure associated with the unit process. The second parameter may be configured based on occurrence time of the teaching spike.

In some implementations, the unit process may be configured to provide a target output. The performance measure may be determined based on a discrepancy between the target output and the output spike.

In some implementations, the determination of the first parameter may be characterized by an adjustment magnitude that is configured based on a time interval between the first sensory spike and the output spike. A time interval may be between the output spike and the teaching spike.

In some implementations, responsive to the first sensory spike preceding the output spike, the adjustment magnitude may be positive. Responsive to the first sensory spike following the output spike, the adjustment magnitude may be negative.

In some implementations, the adjustment magnitude determined based on the time interval between the first sensory spike and the output spike may be diminished in accordance with the time interval between the output spike and the teaching spike.

In some implementations, the adjustment magnitude may be configured based on a time interval between the first sensory spike and the output spike.

In some implementations, the adjustment magnitude may be configured to decrease in accordance with the time interval between the first sensory and the teaching spike.

In some implementations, the second connection may be configured to be operable in accordance with a second connection process characterized by second connection efficacy. The adjustment magnitude determined based on the time interval between the first input spike and the output spike may be modified based on the second connection efficacy.

In some implementations, the modification may comprise a multiplicative operation of the second connection efficacy.

In some implementations, the sensory spike may be feed forward and/or may not depend on the output spike of the neuron.

In some implementations, the first connection may be configured to communicate to the first connection process a timing information associated with occurrence of the first sensory spike via payload comprising two or more bits.

Another aspect of the disclosure relates to a computerized robotic control system. The system may comprise: a sensor apparatus configured to provide sensory input; and a control apparatus comprising a spiking neuron network configured to receive the sensory input and to provide a control signal configured to operate a robotic platform in accordance with a target trajectory. The spiking neuron network may be configured to be operable in accordance with a reinforcement process configured to determine an efficacy of a first connection configured to communicate the sensory input to a neuron. The efficacy determination may be based on: a reinforcement signal provided to the neuron via a connection other than the first connection, the efficacy determination configured comprising; a first time interval between a first portion of the sensory input and an output being provided by the neuron, the first portion preceding the output; a second time interval between the first portion of the sensory input and the reinforcement signal; a third time interval between the output and the reinforcement signal; and a value associated with the reinforcement signal.

In some implementations, the value may be determined based on a performance measure. The performance measure may be determined based on an evaluation of the target trajectory and actual trajectory of the robotic platform. The actual trajectory may be obtained based on the control signal. The value may be positive responsive to the performance measure being within a threshold. The value may be negative responsive to the performance measure being outside the threshold.

In some implementations, the sensory input may be configured to communicate information related to an environment external to the robotic platform. The first portion may comprise a first sensory spike. The reinforcement signal may comprise reinforcement spike. The output may comprise an output spike. The efficacy determination may be effectuated responsive to an occurrence of a second sensory spike of the sensory input subsequent to the reinforcement spike.

Yet another aspect of the disclosure relates to a spiking neuron network apparatus. The apparatus may comprise one or more processors configured to execute computer program modules to cause one or more processors to: operate a first unit of the network in accordance with a first process; operate a first connection in accordance with a second process, the first connection being configured to provide a spiking input into the first unit; operate one or more second connections in accordance with a third process, the one or more second connections being configured to communicate a spike from the first unit; and based on an event associated with the spike, execute: (1) a first update of the first process; and (2) one or more of second updates of the third process associated with individual ones of the one or more second connections. Individual ones of the one or more of second updates of the second process may be configured based on one or more parameters associated with the third process.

In some implementations, the first update of the first process may be configured based on one or more outcomes of the one or more of second updates. The third process may be configured to communicate the one or more parameters to the second process using a payload associated with the spiking input. The payload may be characterized by a plurality of bits.

In some implementations, the first update of the first process may be configured based on one or more outcomes of the one or more of second updates. The first update of the first process may be configured to occur subsequent to determination of individual ones of the one or more outcomes.

In some implementations, the execution of the computer program modules may be configured to cause one or more processors to operate a second unit of the network in accordance with the first process. The second unit may be configured to cause the provision of the spiking input into the first unit via the first connection.

In some implementations, the operation of the second unit in accordance with the first process may be configured to cause a third update of the second process associated with the first connection. Individual ones of the one or more of second updates of the second process may be configured based on one or more parameters associated with the third process.

In some implementations, the execution of the computer program modules may be configured to cause one or more processors to maintain a state of the third process responsive to the event.

In some implementations, the one or more second connections may comprise a plurality of second connections configured to communicate the spike to a plurality of third units. Individual ones of the plurality of second connections may be characterized by a plurality third unit identification numbers. The first process may be configured to access memory associated with individual ones of the plurality of second connections in accordance with a respective identification number. Individual ones of the plurality of third unit identification numbers may be arranged in a sorted array.

In some implementations, the one or more second connections may comprise a plurality of second connections configured to communicate the spike to a plurality of third units. Individual ones of the plurality of second connections may be characterized by a plurality third unit identification numbers.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

FIG. 1A is a block diagram illustrating a spiking neural network for use with event driven updates, in accordance with one or more implementations.

FIG. 1B is a block diagram illustrating a spiking neural network configured in accordance with one or more implementations of hardware-compliant HLND framework.

FIG. 2 is a graphical illustration depicting timing diagram of nearest-neighbor plasticity, in accordance with one or more implementations.

FIG. 3 is a graphical illustration depicting timing diagram of one-to-all plasticity, in accordance with one or more implementations.

FIG. 4 is a graphical illustration depicting timing diagram of all-to-all plasticity, in accordance with one or more implementations.

FIG. 5 is a block diagram illustrating a spiking neural network configured for reward-based training using event-driven update methodology, in accordance with one or more implementations.

FIG. 6 is a graphical illustration depicting timing diagram of a reward-based all-to-all plasticity for use with the network of FIG. 5, in accordance with one or more implementations.

FIG. 7 is a logical flow diagram illustrating event-based synapse update execution in spiking neuron network, in accordance with one or more implementations.

FIG. 8 is a logical flow diagram illustrating operation of a spiking neuron network based on occurrence of a teaching event, in accordance with one or more implementations.

FIG. 9 is a logical flow diagram illustrating implementation of reward based plasticity in the network of FIG. 5, in accordance with one or more implementations.

FIG. 10 is a block diagram illustrating sensory processing apparatus configured to implement event driven update mechanism in a spiking network, in accordance with one or more implementations.

FIG. 11A is a block diagram illustrating computerized system useful with event driven update mechanism in a spiking network, in accordance with one or more implementations.

FIG. 11B is a block diagram illustrating a neuromorphic computerized system useful with event driven update mechanism in a spiking network, in accordance with one or more implementations.

FIG. 11C is a block diagram illustrating a hierarchical neuromorphic computerized system architecture useful with event driven update mechanism in a spiking network, in accordance with one or more implementations.

FIG. 11D is a block diagram illustrating cell-type neuromorphic computerized system architecture useful event driven update mechanism in a spiking network, in accordance with one or more implementations.

FIGS. 12A, 12B, 12C, 12D, 12E, 12F, and 12G include a program listing illustrating an exemplary implementation of event based plasticity in a spiking neuron network.

FIGS. 13A and 13B include a program listing illustrating an exemplary implementation of one-to-all plasticity in a spiking neuron network.

FIGS. 14A, 14B, and 14C include a program listing illustrating an exemplary implementation of all-to-all plasticity in a spiking neuron network.

FIGS. 15A and 15B include a program listing illustrating an exemplary implementation of nearest-neighbor plasticity in a spiking neuron network.

FIGS. 16A, 16B, 16C, and 16D include a program listing illustrating various exemplary methods for implementing reward-based plasticity in a spiking neuron network.

FIGS. 17A, 17B, 17C, 17D, 17E, and 17F include a program listing illustrating an exemplary implementation of all-to-all reward-based plasticity in a spiking neuron network.

All Figures disclosed herein are © Copyright 2013 Brain Corporation. All rights reserved.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to a single implementation or implementation, but other implementations and implementations are possible by way of interchange of or combination with some or all of the described or illustrated elements. Wherever convenient, the same reference numbers will be used throughout the drawings to refer to same or like parts.

Where certain elements of these implementations can be partially or fully implemented using known components, only those portions of such known components that are necessary for an understanding of the present disclosure will be described, and detailed descriptions of other portions of such known components will be omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote all types of interconnection or communication architecture that is used to access the synaptic and neuron memory. The “bus” may be optical, wireless, infrared, and/or another type of communication medium. The exact topology of the bus could be for example standard “bus”, hierarchical bus, network-on-chip, address-event-representation (AER) connection, and/or other type of communication topology used for accessing, e.g., different memories in pulse-based system.

As used herein, the terms “computer”, “computing device”, and “computerized device“may include one or more of personal computers (PCs) and/or minicomputers (e.g., desktop, laptop, and/or other PCs), mainframe computers, workstations, servers, personal digital assistants (PDAs), handheld computers, embedded computers, programmable logic devices, personal communicators, tablet computers, portable navigation aids, J2ME equipped devices, cellular telephones, smart phones, personal integrated communication and/or entertainment devices, and/or any other device capable of executing a set of instructions and processing an incoming data signal.

As used herein, the term “computer program” or “software” may include any sequence of human and/or machine cognizable steps which perform a function. Such program may be rendered in a programming language and/or environment including one or more of C/C++, C#, Fortran, COBOL, MATLAB™, PASCAL, Python, assembly language, markup languages (e.g., HTML, SGML, XML, VoXML), object-oriented environments (e.g., Common Object Request Broker Architecture (CORBA)), Java™ (e.g., J2ME, Java Beans), Binary Runtime Environment (e.g., BREW), and/or other programming languages and/or environments.

As used herein, the terms “connection”, “link”, “transmission channel”, “delay line”, “wireless” may include a causal link between any two or more entities (whether physical or logical/virtual), which may enable information exchange between the entities.

As used herein, the term “memory” may include an integrated circuit and/or other storage device adapted for storing digital data. By way of non-limiting example, memory may include one or more of ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, PSRAM, and/or other types of memory.

As used herein, the terms “integrated circuit”, “chip”, “system on a chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), application-specific integrated circuits (ASICs), and/or other types of integrated circuits.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., 3G, LTE/LTE-A/TD-LTE, GSM, etc.), IrDA families, and/or other network interfaces.

As used herein, the terms “node”, “neuron”, and “neuronal node” are meant to refer, without limitation, to a network unit (e.g., a spiking neuron and a set of synapses configured to provide input signals to the neuron) having parameters that are subject to adaptation in accordance with a model.

As used herein, the terms “state” and “node state” is meant generally to denote a full (or partial) set of dynamic variables used to describe node state.

As used herein, the term “synaptic channel”, “connection”, “link”, “transmission channel”, “delay line”, and “communications channel” include a link between any two or more entities (whether physical (wired or wireless), or logical/virtual) which enables information exchange between the entities, and may be characterized by a one or more variables affecting the information exchange.

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

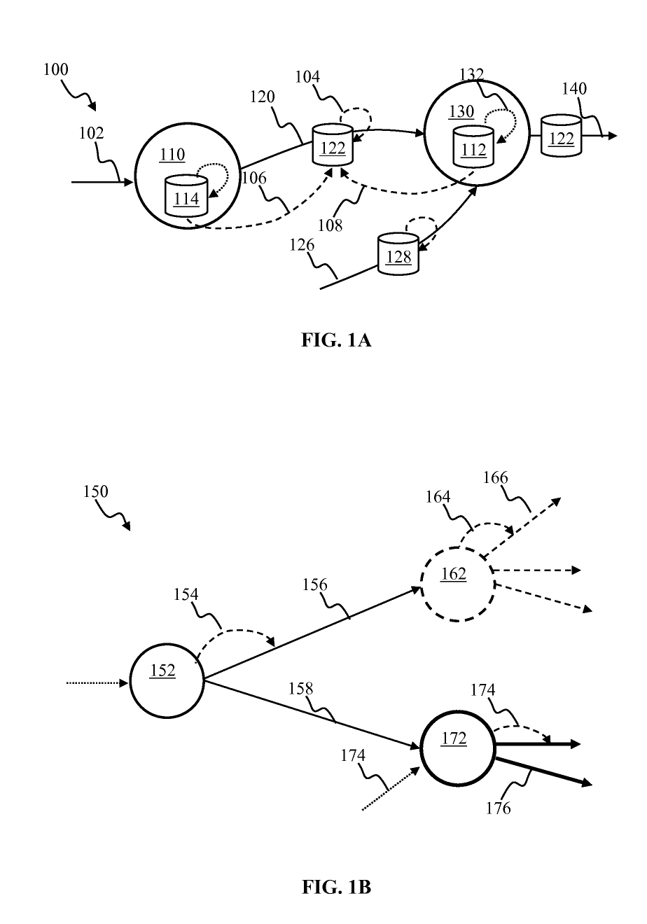

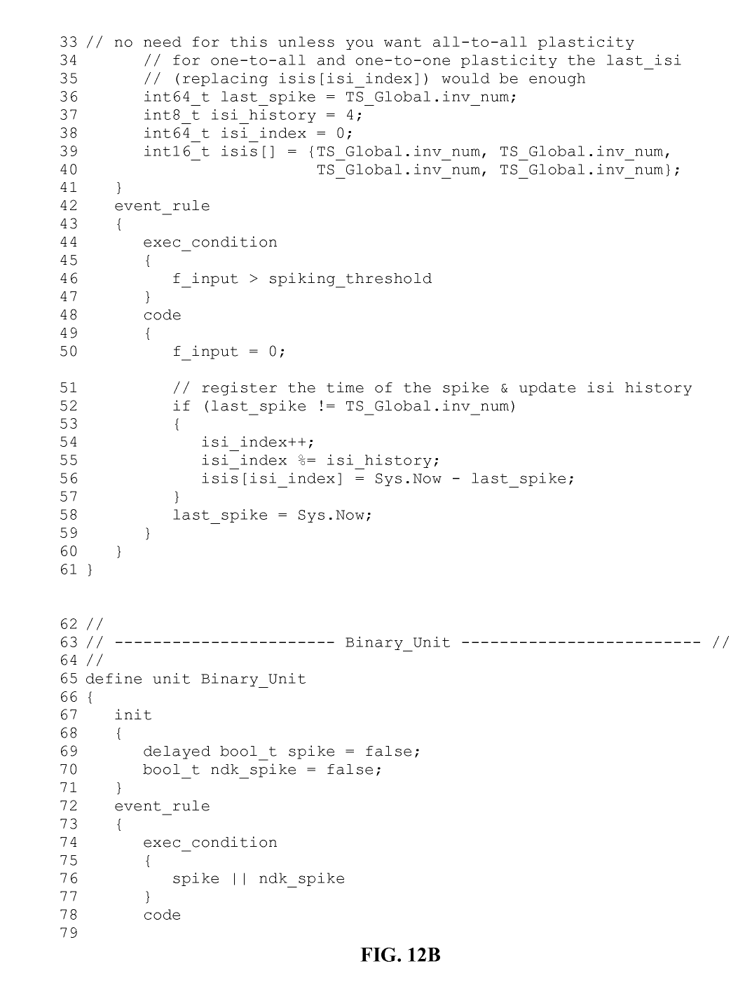

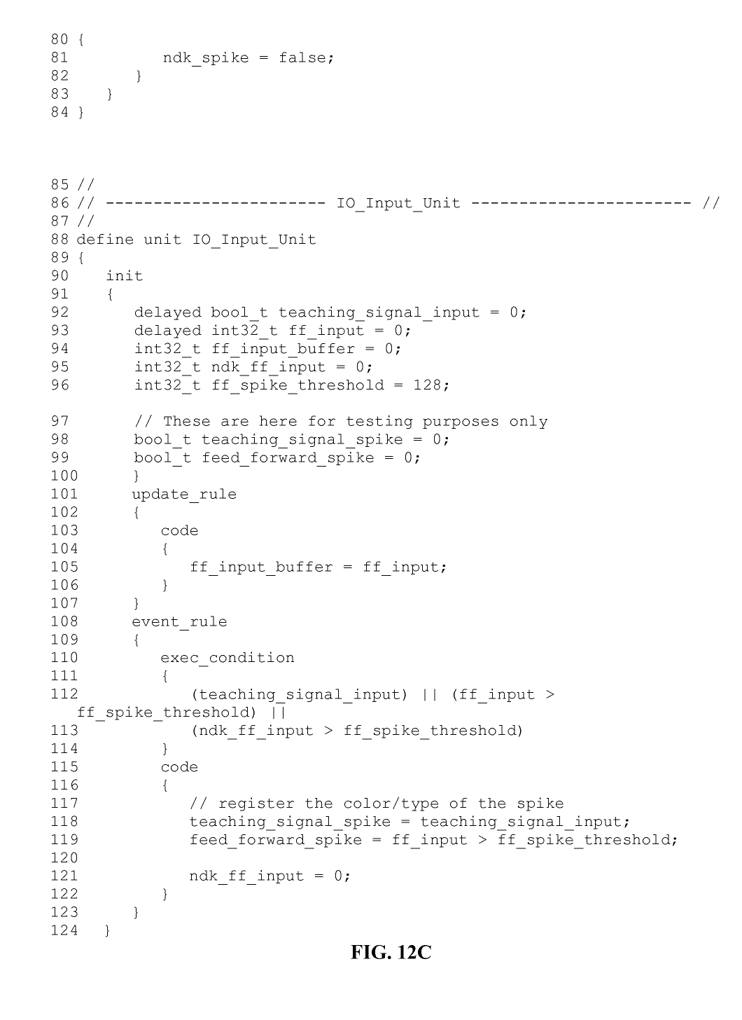

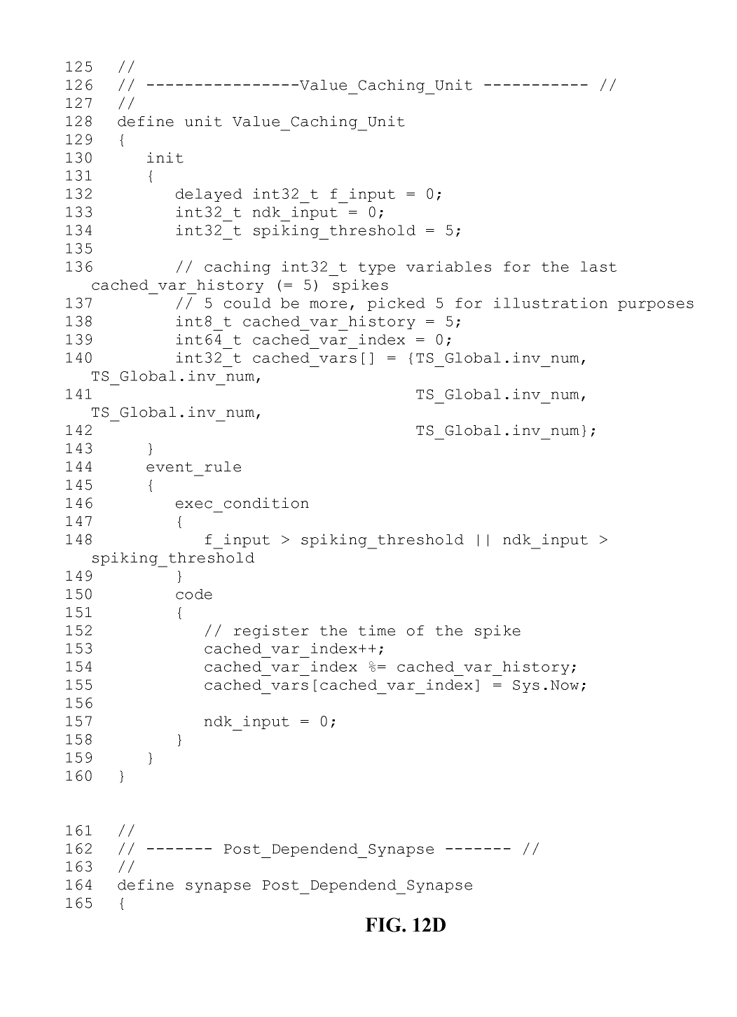

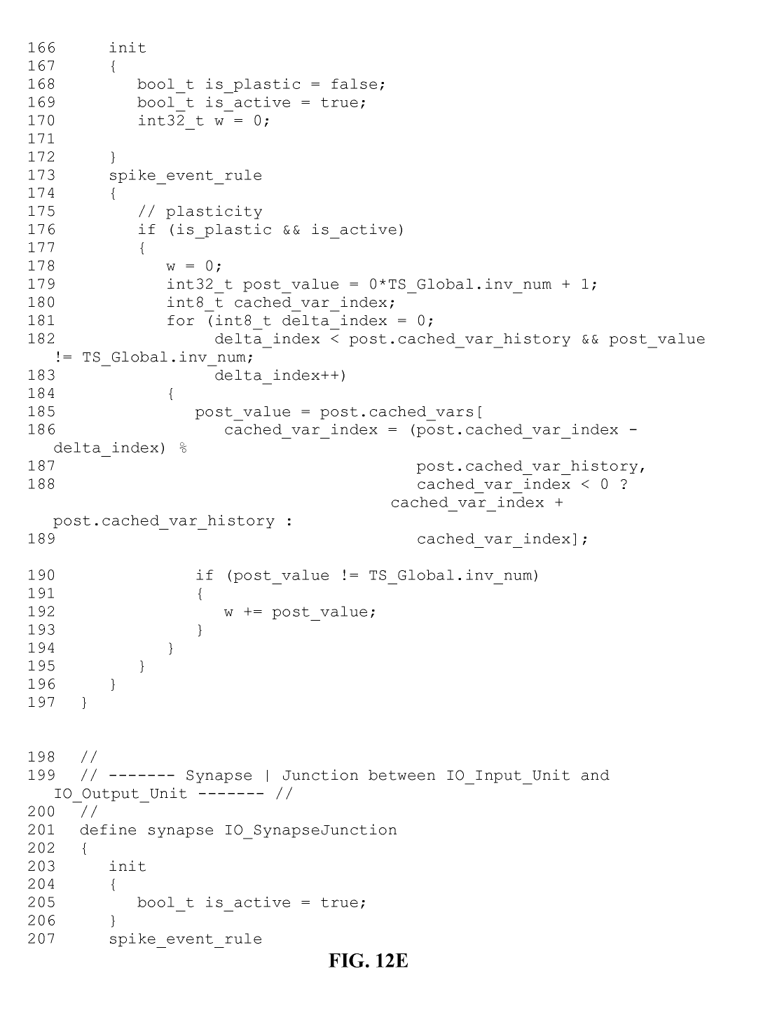

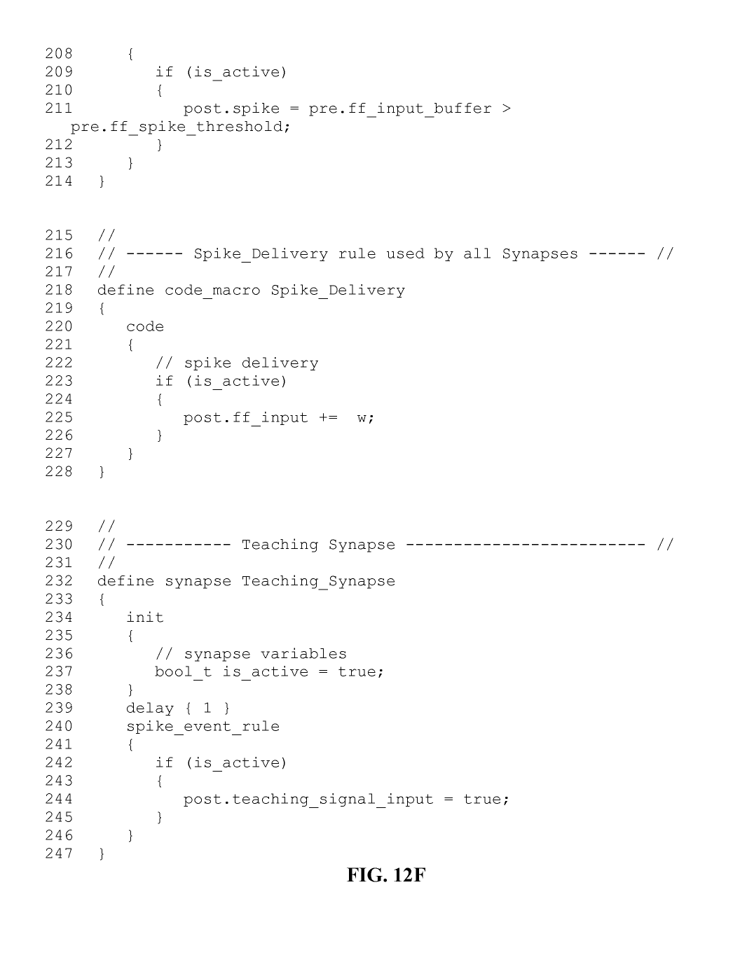

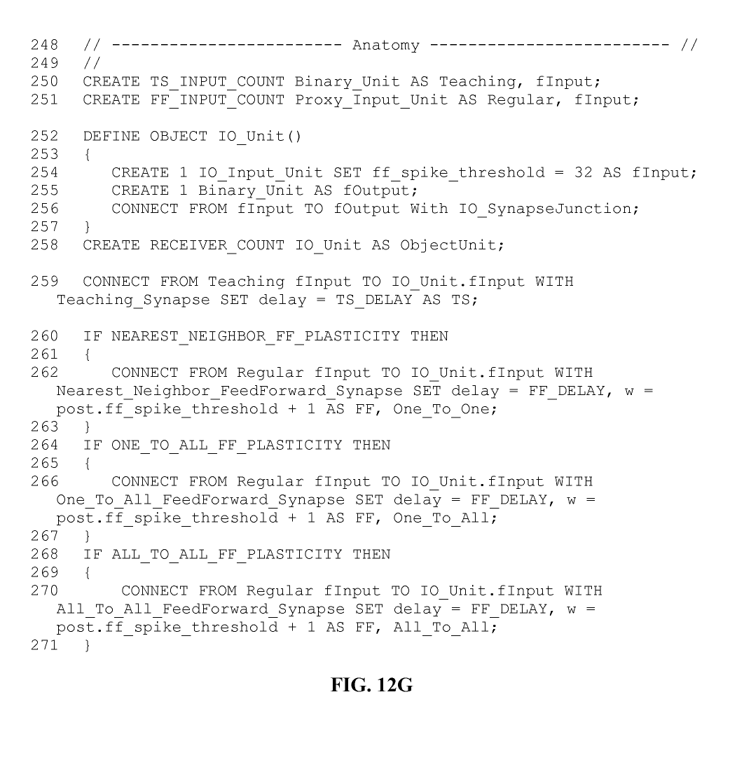

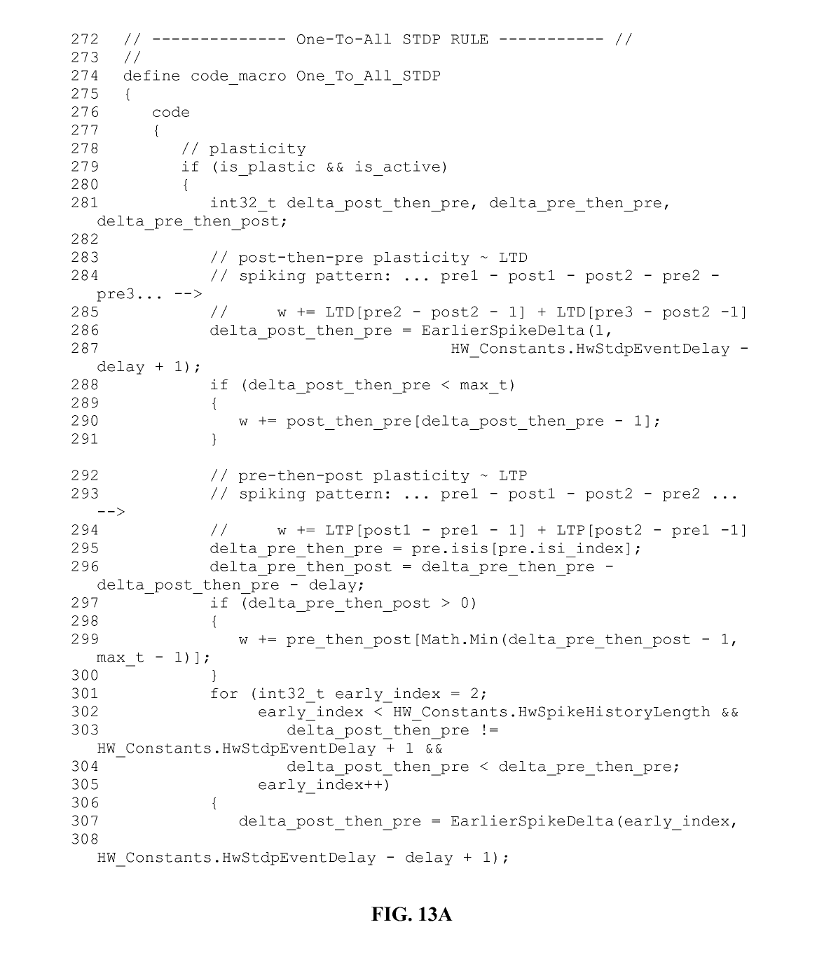

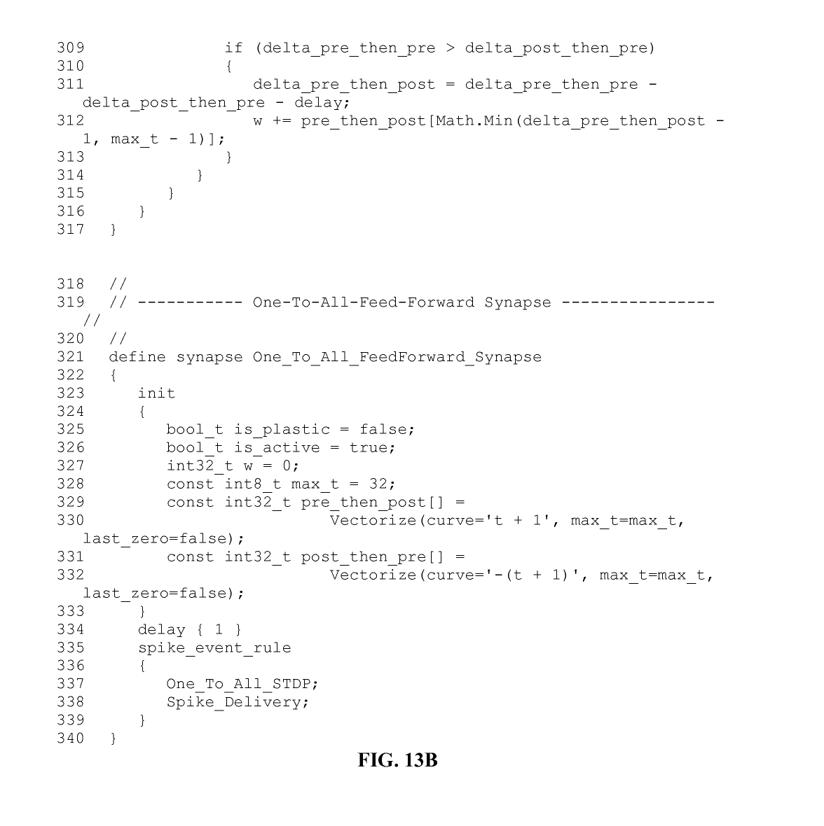

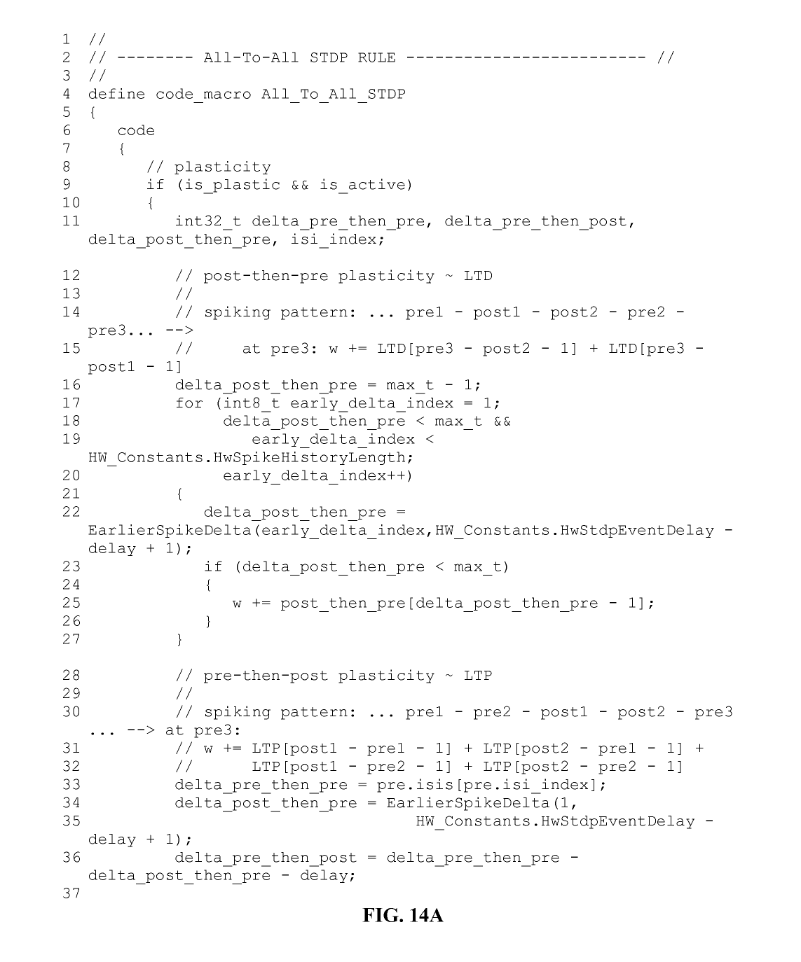

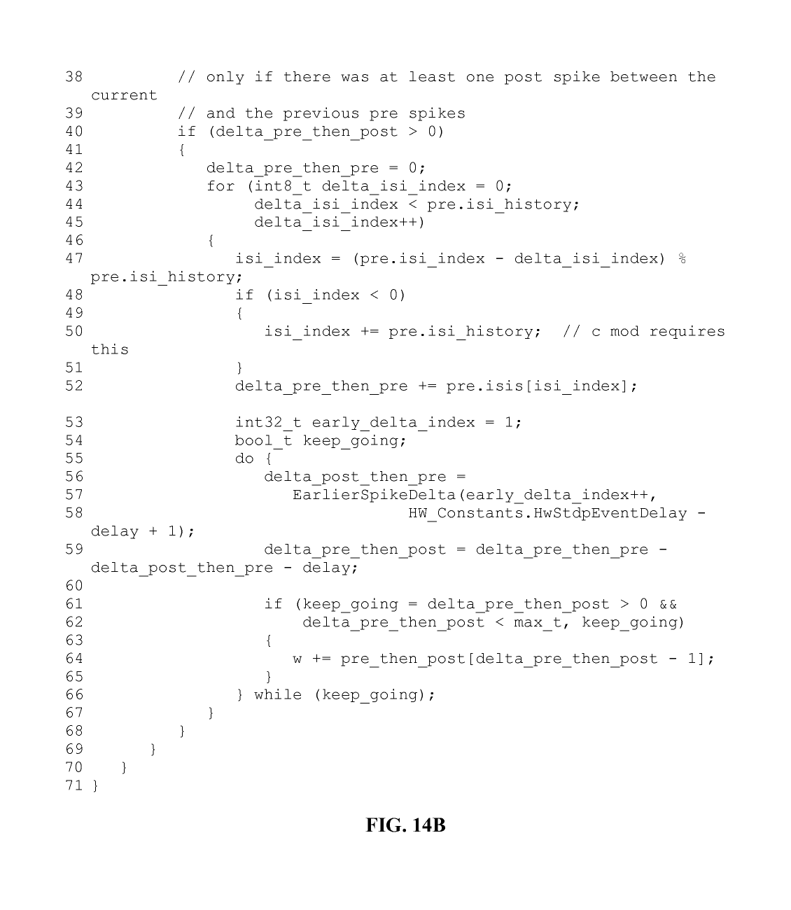

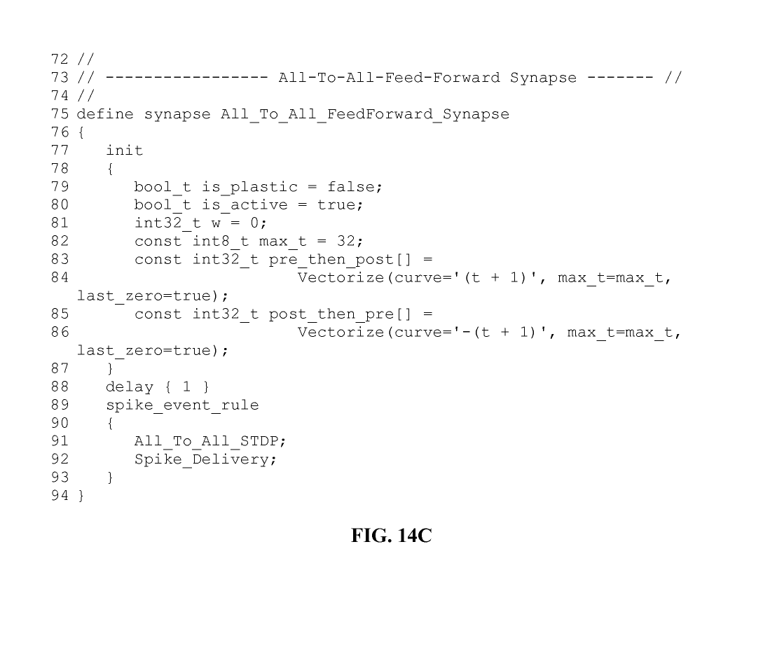

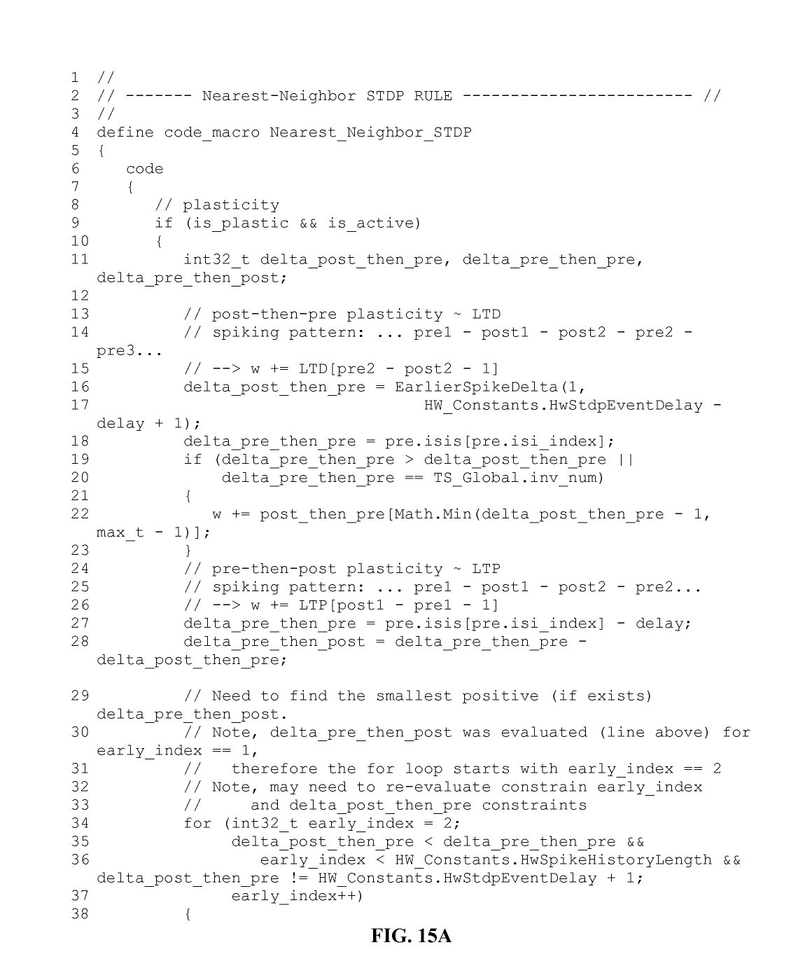

FIG. 1A illustrates an exemplary spiking neuron network configured for event-based data communication in accordance with one or more implementations. The network 100 may comprise a plurality of spiking units (e.g., 110, 130) interconnected by synapses (or connections) (e.g., 102, 120, 126, 140). In some implementations, the units of the network 100 may comprise one or more unit types; the connections of the network 100 may comprise one or more connection types, e.g., as illustrated in FIGS. 12A-13B.

Individual units may be allocated unit memory 112, 114 configured to store, inter alia, state data of the respective unit. In one or more implementations, such as described in e.g., U.S. patent application Ser. No. 13/152,105, filed Jun. 2, 2011 and entitled “APPARATUS AND METHODS FOR TEMPORALLY PROXIMATE OBJECT RECOGNITION” and/or U.S. patent application Ser. No. 13/487,533, filed Jun. 4, 2012 and entitled “STOCHASTIC SPIKING NETWORK LEARNING APPARATUS AND METHODS”, each of the foregoing being incorporated herein by reference in its entirety, the state parameter may comprise unit excitability, firing threshold, stochasticity parameter, and/or other.

The units may be operated in accordance with one or more unit update rules. Unit update rules may be configured to access (read & write) memory (e.g., 112) of the respective unit (e.g., 130). This access is shown by the dotted line arrows 132 in FIG. 1A. The unit update rule may be configured to be executed periodically, e.g., based on local or global timer. Based on execution of the unit update rule, a unit may generate an event (also called spike). Units may configure a payload associated with the spike. The payload may be stored in unit memory (e.g., 112 in FIG. 1A).

A unit event may trigger spike delivery for outgoing synapses (e.g., synapse 140 for the unit 130); and/or execution of one or more plasticity rules associated with incoming synapses (e.g., the connections 120, 126 of the unit 130). In some implementation, spike delivery may be implemented by the synapses.

The units 110, 130 may communicate with one another by means of spikes. With respect to the connection 120, the units 110, 130 may be referred to as the pre-synaptic and the post-synaptic unit, respectively. It is noteworthy, that the same unit may be referred to as both the pre-synaptic unit (e.g., the unit 130 with respect to the connection 140) and the post-synaptic unit (e.g., the unit 130 with respect to the connection 120). Individual connections (e.g., 120) may be assigned, inter alia, a connection efficacy, which in general may refer to a magnitude and/or probability of input spike influence on unit output response (e.g., output spike generation/firing). The efficacy may comprise, for example a parameter (e.g., synaptic weight) used for adaptation of one or more state variables of post-synaptic units (e.g., 130). The efficacy may comprise a latency parameter by characterizing propagation delay from a pre-synaptic unit to a post-synaptic unit. In some implementations, greater efficacy may correspond to a shorter latency. In some other implementations, the efficacy may comprise probability parameter by characterizing propagation probability from pre-synaptic unit to a post-synaptic unit; and/or a parameter characterizing an impact of a pre-synaptic spike on the state of the post-synaptic unit.

Individual synapses may be operated in accordance with one or more synapse-rules. The synapse (e.g., 120) rule may be configured to: access (read/write) memory of the connection; read/write memory of the post-synaptic unit (e.g., 130); and read memory of the pre-synaptic unit (e.g., 110). Synapse memory 122 access by the synapse 120 rule is shown by broken line arrow 104 for the connection 120. Post-synaptic unit 130 memory access by the synapse 120 rule is shown by broken line arrow 108. Pre-synaptic unit 130 memory access by the synapse 120 rule is shown by broken line arrow 106.

In one or more implementations, the synapse rules may comprise an update rule and/or plasticity rule. The update rule may be executed periodically (e.g., at 1 ms-100 ms intervals based on a timer). The update rule may be utilized to adjust (e.g., discount) connection efficacy in accordance with a connection dynamic process. In some implementations, the connection dynamic process may comprise an exponential decay of connection weight, e.g. as described in commonly owned U.S. patent application Ser. No. 13/548,071, filed Jul. 12, 2012 and entitled “SPIKING NEURON NETWORK SENSORY PROCESSING APPARATUS AND METHODS”, and U.S. patent application Ser. No. 13/560,891, filed Jul. 27, 2012, and entitled “APPARATUS AND METHODS FOR EFFICIENT UPDATES IN SPIKING NEURON NETWORKS”, each of the foregoing being incorporated herein by reference in its entirety.

Individual connections may be allocated connection memory 122, 128 configured to store, inter alia, the efficacy. In one or more implementations, the network 100 may comprise millions of units and millions or billions of connections. As a result, such pulse-coded network may require access, modification, and/or storing of a large number of synaptic variables (typically many millions to billions) in order to implement learning.

The synaptic variables of a spiking network may be stored and addressed using pre-synaptic indexing, e.g., as described in U.S. patent application Ser. No. 13/239,259, filed Sep. 21, 2011 and entitled “APPARATUS AND METHODS FOR PARTIAL EVALUATION OF SYNAPTIC UPDATES BASED ON SYSTEM EVENTS”, incorporated supra. The pre-synaptically indexed network of FIG. 1A, synaptic variables corresponding to synaptic connections that deliver outputs from a given pre-synaptic unit (such as the unit 110 in FIG. 1A) may be stored in a pre-synaptically indexed memory (that is based, for example, on the pre-synaptic unit ID).

The plasticity rule of a given connection may be configured to be executed based on an event (e.g., a spike generation) of the pre-synaptic unit associated with the given connection. That is, responsive to the unit 110 generating a spike, the plasticity rule execution for the connection 120 may be triggered.

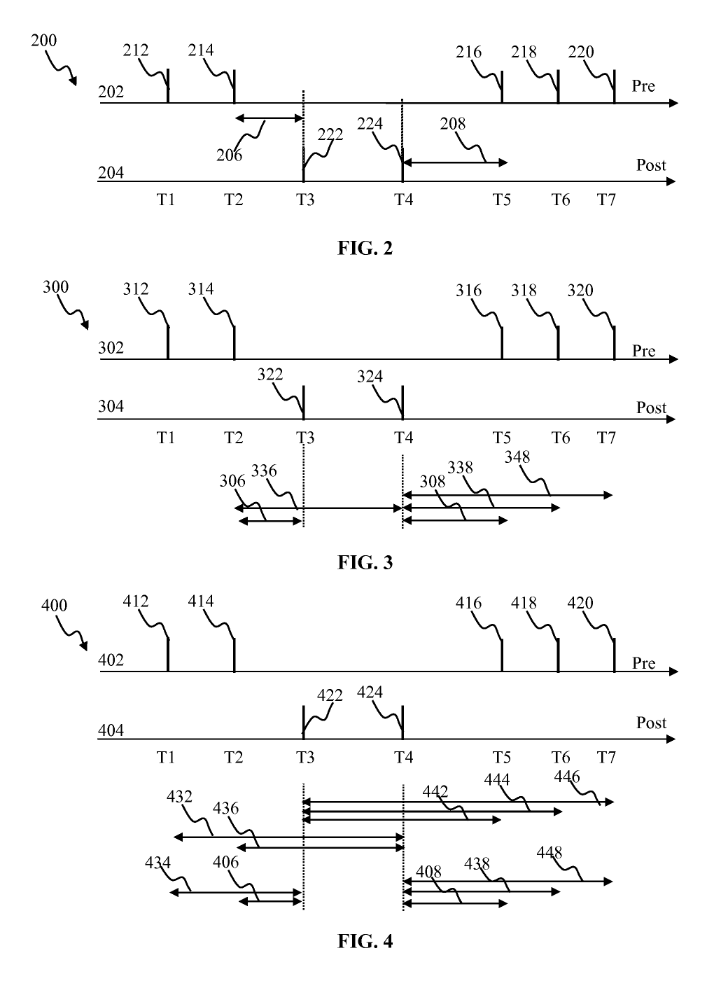

In some implementations, plasticity rule of a connection (e.g., 120, 140) may be configured based on timing of pre-synaptic and post-synaptic activity (e.g., spike-timing dependent plasticity (STDP)), as described below with respect to FIGS. 2-4 and 6.

FIG. 1B illustrates an exemplary spiking neuron network configured for operation in accordance with one or more implementations of hardware-compliant high-level neuromorphic language description (HLND) framework. The network 150 may comprise a plurality of spiking units (e.g., 152, 162, 172) interconnected by synapses (or connections) (e.g., 156, 158, 166, 178). In some implementations, the units of the network 150 may comprise one or more unit types; the connections of the network 150 may comprise one or more connection types.

The units and the connections of the network 150 may be operated in accordance with one or more unit/connection update rules, respectively. Unit update rules may be configured compliant with hardware HLND framework. In some implementation, the hardware compliance may comprise preventing the unit update rule (triggered by the unit event) from accessing (reading and/or writing) memory of incoming connection (e.g., the connection 158 with respect to the unit 172 in FIG. 1B). In FIG. 1B, curves of different line style denote components of the network that may be updated responsive to a given unit event (e.g., spike generation). By way of illustration, an event 154 associated with a spike generation by the unit 152 may cause execution of update rules for: the unit 152 and the connections 154, 158; an event 164 associated with a spike generation by the unit 162 may cause execution of update rules for: the unit 162 and its outgoing connections (e.g., 166); and an event 174 associated with a spike generation by the unit 172 may cause execution of update rules for: the unit 162 and its outgoing connections (e.g., 176) in FIG. 1B. The memory access configuration described with respect to FIGS. 1A-1B may optimize connection memory access by the units of the network. In some implementations, the memory access optimization may be configured by indexing connections associated with a unit based on IDs of outgoing (postsynaptic) connections.

FIG. 2 depicts a timing diagram for implementing nearest-neighbor plasticity in a spiking neuron network (e.g., the network of FIG. 1A), in accordance with one or more implementations. The traces 202, 204 in the diagram 200 denote pre-synaptic and post-synaptic unit activity as a function of time. In some implementations, plasticity rule execution may comprise adjusting efficacy/weight of a connection (e.g., the connection 120 in FIG. 1A). The pre-synaptic activity may comprise spikes 212, 214, 216, 218,220 generated by the unit 110 in FIG. 1A; the post-synaptic activity may comprise spikes 222, 224 generated by the unit 130 in FIG. 1A.

In some implementations, for a given post synaptic event (e.g., 222) the nearest-neighbor plasticity may comprise connection efficacy adjustments based on one or more of: (i) time difference between most recent pre-synaptic spike 214 occurring prior to the event 222 (e.g., the interval 206 in FIG. 2); (ii) time difference between earliest (e.g., the first) pre-synaptic event (e.g., 216) occurring subsequent to the latest post-synaptic event (e.g., the interval 208 for the last post event in FIG. 2 224); and/or other information.

Time interval 206 may correspond to the causal portion of the STDP rule, wherein the input into a unit (e.g., the pre-event 214) precedes the unit response (e.g., the post event 222). In some implementations, the causal STDP portion may comprise long-term connection potentiation (LTP) See, e.g., description in co-owned U.S. patent application Ser. No. ______ filed Jul. 30, 2013 and entitled “APPARATUS AND METHODS FOR EFFICACY BALANCING IN A SPIKING NEURON NETWORK”.

Time interval 208 may correspond to anti-causal portion of the STDP rule, wherein the input into a unit (e.g., the pre-event 216) follows the unit response (e.g., the post event 222). In some implementations, the anti-causal STDP portion may comprise long-term connection depression (LTD). See, e.g., description in co-owned U.S. patent application Ser. No. 13/954,575 filed Jul. 30, 2013 and entitled “APPARATUS AND METHODS FOR EFFICACY BALANCING IN A SPIKING NEURON NETWORK”. As used herein, connection potentiation/depression may refer to efficacy change configured to, respectively, increase/decrease probability and/or advance/delay time of response generation by post-synaptic unit based on the pre-synaptic event.

In one or more implementations, spike time may describe time of spike receipt expressed as time of day in, e.g., ms, time relative to an event (e.g., ms since last spike, or from start of operation), and/or in counter value relative an event. In one or more implementations, the spike time may describe spike generation time communicated via, e.g., spike payload, and/or a spike queue.

The weight update corresponding to the timing shown in FIG. 2 may be performed as follows:

w+=LTP(Δ₊)+LTD(Δ₋), (Eqn. 1)

where:
w denotes synaptic efficacy;
Δ₊ denotes the time interval between the post-synaptic event and the preceding pre-synaptic event (e.g., 206 in FIG. 2); and
Δ₋ denotes the time interval between the post-synaptic event and the earliest following pre-synaptic event (e.g., 208 in FIG. 2).

In some implementations of the nearest neighbor plasticity mechanism illustrated in FIG. 2, efficacy update of Eqn. 1 for the connection 120 may be triggered by the pre-synaptic event 216 associated with the unit 110 in FIG. 1A. A delivery rule associated with the connection efficacy update of Eqn. 1 may be expressed as:

post.input+=w, (Eqn. 2)

FIGS. 12A-G illustrates an exemplary definition of spike delivery rule using HLND; FIGS. 13A-B, 14A-C, 17A-F illustrate use of the spike delivery of Eqn. 2. In the plasticity rule implementation of FIG. 2, pre-synaptic events 214, 218, 220 at times T2, T5, T6, respectively, may be configured to not to trigger plasticity rule execution. In some implementations, the pre-synaptic event 212 may trigger plasticity rule execution based on occurrence of a prior post-synaptic event (not shown).

As may be seen from FIG. 2, plasticity rule execution may utilize event timing information for pre-synaptic and post-synaptic units. In some implementations, timing of post-synaptic events may be stored in the post synaptic unit memory (e.g., memory 122 of the unit 130 in FIG. 1A). The post-synaptic unit memory may be accessible by a synapse (e.g., the unit 130 memory 112 may be read by synapses 120, 126, as shown by the arrow 108 in FIG. 1A). In some implementations, timing of the pre-synaptic event may be stored in the pre synaptic unit memory that may be accessible by a synapse (e.g., the unit 110 memory 114 may be available to the synapse 120, as shown by the arrow 106 in FIG. 1A). In one or more implementations, contents of the pre-synaptic unit memory may be provided to the synapse via spike payload, for example, as described in detail in U.S. patent application Ser. No. 13/868,944, filed Apr. 23, 2013 and entitled “APPARATUS AND METHODS FOR EVENT-BASED COMMUNICATION IN A SPIKING NEURON NETWORK”, incorporated supra.

The payload may correspond to one or more bits of information (in addition to occurrence of the spike itself) that may be communicated from a source (e.g., a pre-synaptic neuron and/or a teacher) to a target (e.g., a post-synaptic neuron). In some implementations, such spikes with payload may be characterized by a spike amplitude and/or finite spike duration (spike width). Area associated with spike amplitude and width may be utilized to encode the payload (e.g., greater area may correspond to a large number of bits in the payload).

In one or more implementations, the payload may be stored in a buffer of presynaptic unit and the connection may be configured to access the presynaptic neuron memory buffer. In some implementations, the presynaptic unit may be configured to modify the payload based on one or more parameters (e.g., state) of the presynaptic unit.

In some implementations, the payload may be stored in a buffer of the connection and the postsynaptic unit may be configured to access the connection memory buffer.

In one or more implementations, the payload may be stored in a buffer of the connection. The connection may be configured to modify the payload based on one or more parameters (e.g., state) of the presynaptic unit. This configuration may allow for configuring payload content in accordance with the type of a synapse outgoing from a given unit.

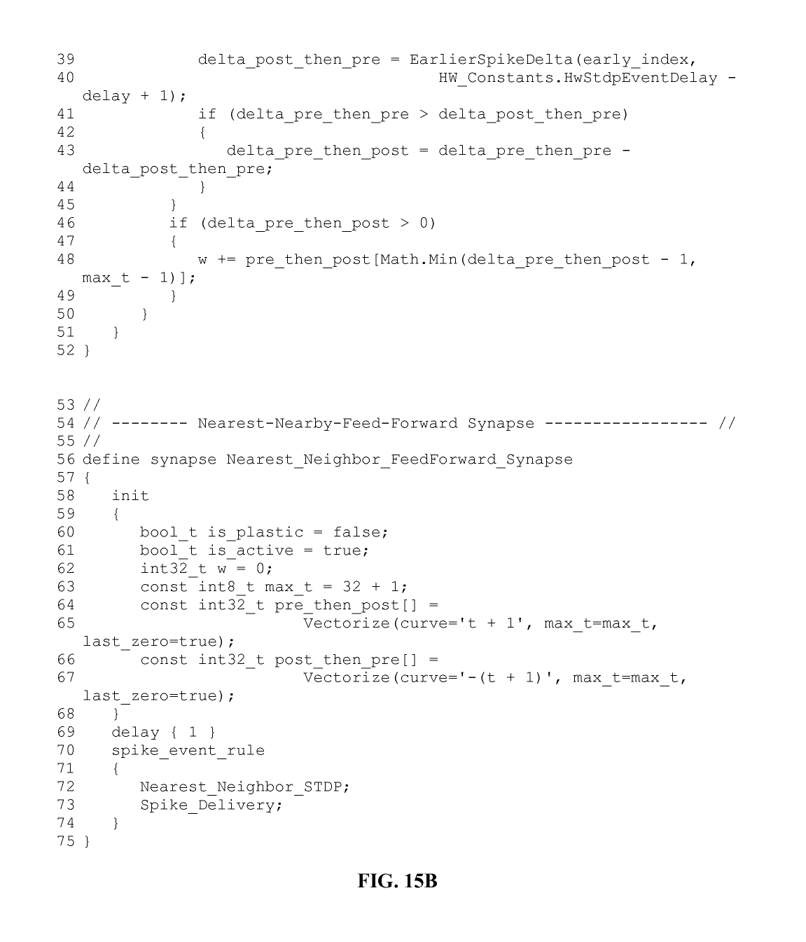

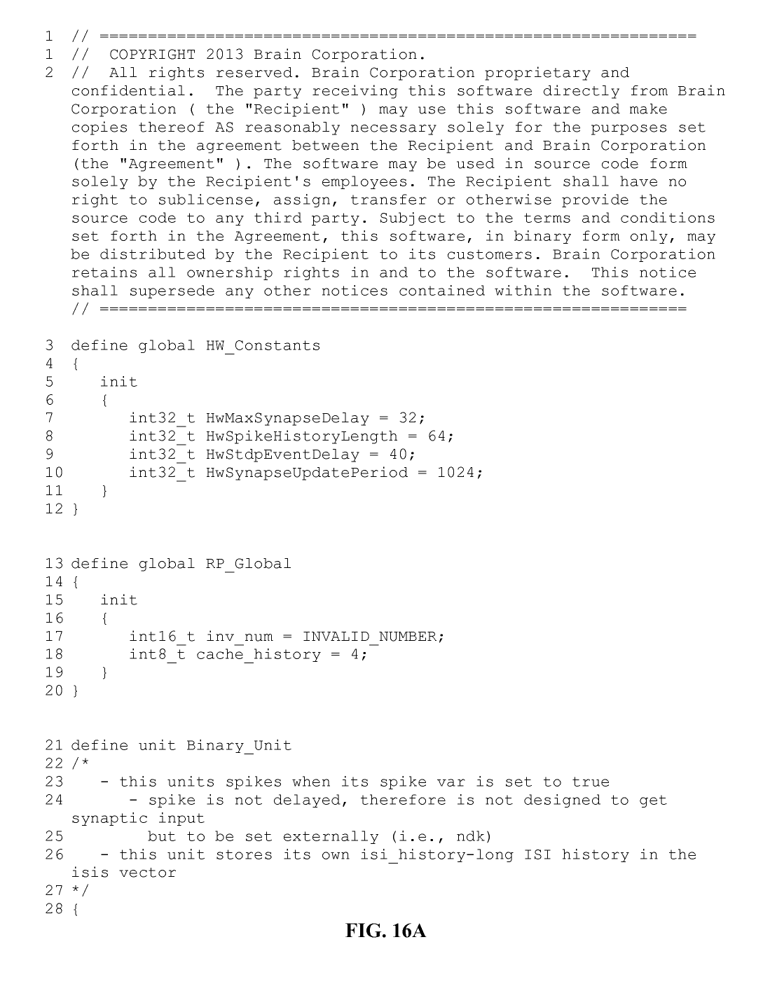

In some implementations, the payload may be packaged by the network update engine into a data package that may be delivered by the connection. FIGS. 15A-B illustrates an exemplary implementation of the nearest-neighbor plasticity mechanism of FIG. 2 using HLND.

FIG. 3 depicts a timing diagram for implementing one-to-all plasticity in a spiking neuron network (e.g., the network of FIG. 1A), in accordance with one or more implementations. The traces 302, 304 in the diagram 300 denote pre-synaptic and post-synaptic unit activity as a function of time. In some implementations, plasticity rule execution may comprise adjusting efficacy of a connection (e.g., the connection 120 in FIG. 1A). The pre-synaptic activity may comprise spikes 312, 314, 316, 318, 320 generated by the unit 110 in FIG. 1A; the post-synaptic activity may comprise spikes 322, 324 generated by the unit 130 in FIG. 1A. As illustrated in FIG. 3, the synaptic efficacy update (e.g., of the synapse 120 connecting the pre unit 110 to the post unit 130) may be executed at the time of pre-synaptic events 316, 318, 320. Magnitude of efficacy changes may be configured based on the relative timing between respective post-synaptic 322, 324 events occurring at times T3, T4, respectively, and pre-synaptic events 314, 316, 318, 320, occurring at times T2, T5, T6, T7 in FIG. 3.

As illustrated in FIG. 3, for a given post-synaptic event (e.g., 322, 324), the closest preceding pre-synaptic event (e.g., 314) may be used for determining time intervals 306, 336 used in synaptic efficacy update. Time interval 306, 336 may correspond to the causal portion of the STDP rule, wherein the input into a unit (e.g., the pre-event 314) precedes the unit response (e.g., the post events 322, 324). In some implementations, the causal STDP portion associated with the time intervals 306, 336 may comprise LTP.

The anti-causal STDP portion of the plasticity rule of FIG. 3 may be configured based on time intervals 308, 338, 348. Based on occurrence of multiple post-synaptic events (e.g., 322, 324 in FIG. 3) the most recently occurring event (e.g., 324) may be utilized in determining the time intervals between the post-synaptic event and individual subsequently occurring pre-synaptic events (e.g., 316, 318, 320 in FIG. 3). Time intervals 308, 338, 348 may correspond to anti-causal portion of the STDP rule, wherein the input into a unit (e.g., the pre-event 316) follows the unit response (e.g., the post event 324). In some implementations, the anti-causal STDP portion may comprise LTD.

Efficacy updates that may be triggered by the pre-synaptic event 316 in FIG. 3 occurring at time T₅, may be performed as follows:

w(T₅)+=ΣLTP[Δ₊]+ΣLTD[Δ₋], (Eqn. 3)

ΣLTP[Δ₊]=LTP[(T₃−T₂)]+LTP[(T₄−T₃)], (Eqn. 4)

ΣLTD[Δ₋]=LTD[(T₅−T₄)]; (Eqn. 5)

where:
w denotes synaptic efficacy;
Δ₊ denotes the time interval between the post-synaptic event at time Tᵢ and the preceding pre-synaptic event at time Tⱼ; and
Δ₋ denotes the time interval between the post-synaptic event at time Tⱼ and the earliest following pre-synaptic event at time Tᵢ.

Efficacy updates that may be triggered by the pre-synaptic events 318, 320 in FIG. 3 occurring at times T₆, T₇, respectively, may be performed as follows:

w(Tₖ)+=LTD[(Tₖ−T₄)], (Eqn. 6)

where Tₖ={T₆, T₇}.

In some implementations of the one-to-all plasticity mechanism illustrated in FIG. 3, efficacy update of Eqn. 3-Eqn. 5 for the connection 120 may be triggered by the pre-synaptic events associated with the unit 110. In the plasticity rule implementation of FIG. 3, pre-synaptic event 314 at time T2 may be configured to not to trigger plasticity rule execution. In some implementations, the pre-synaptic event 312 may trigger plasticity rule execution based on occurrence of a prior post-synaptic event (not shown).

FIG. 4 depicts a timing diagram for implementing all-to-all plasticity in a spiking neuron network (e.g., the network of FIG. 1A). in accordance with one or more implementations. The traces 402, 404 in the diagram 400 denote pre-synaptic and post-synaptic unit activity as a function of time. In some implementations, plasticity rule execution may comprise adjusting efficacy of a connection (e.g., the connection 120 in FIG. 1A). The pre-synaptic activity may comprise spikes 412, 414, 416, 418, 420 generated by, e.g., the unit 110 in FIG. 1A; the post-synaptic activity may comprise spikes 422, 424 generated by the unit 130 in FIG. 1A. In the implementation illustrated in FIG. 4, the synaptic efficacy update (e.g., of the synapse 120 connecting the pre unit 110 to the post unit 130) may be executed at the time of pre-synaptic events 416, 418, 420. Magnitude of efficacy changes may be configured based on the relative timing between individual post-synaptic events 422, 424 occurring at times T3, T4, respectively, and individual pre-synaptic events 412, 414, 416, 418, 420, occurring at times T1, T2, T5, T6, T7, respectively, in FIG. 4.

As illustrated in FIG. 4, a pre-synaptic event that is preceded by one or more post synaptic events (e.g., pre events 416, 418, 420 preceded by post events 422, 424) may be configured to trigger plasticity rule execution. In FIG. 4, because the pre-synaptic events 412, 414 are not preceded by a post-synaptic event the plasticity rule execution rule is not triggered. In some implementations (not shown), the pre-synaptic events 412, 414 may trigger plasticity rule execution based on occurrence of a prior post-synaptic event.

Based on occurrence of a given pre-synaptic event of the events 416, 418, 420 in FIG. 4, the following operations may be performed during plasticity rule execution: one or more preceding post-synaptic events (e.g., 422, 424) may be used for: (i) determining time intervals 408, 438, 442, 444, 446, 448 utilized in the anti-causal portion of synaptic efficacy update; and (ii) determining time intervals 406, 432, 434, 436 utilized in the causal portion synaptic efficacy update, in some implementations.

By way of a non-limiting example, at time T₅ associated with occurrence of the pre-synaptic event 416 in FIG. 4, connection plasticity rule execution may triggered and efficacy update may be determined as follows:

w+=ΣLTP[Δ₊]+ΣLTD[Δ₋(T₅)], (Eqn. 7)

ΣLTP[Δ₊]=LTP[(T₃−T₁)]+LTP[(T₄−T₁)]+LTP[(T₃−T₂)]+LTP[(T₄−T₂)], (Eqn. 8)

ΣLTD[Δ₋(T₅)]=LTD[(T₅−T₄)]+LTD[(T₅−T₃)]. (Eqn. 9)

At times T₆, T₇ associated with occurrence of the pre-synaptic events 418, 420 in FIG. 4, respectively, plasticity rule may be triggered and the efficacy update may be determined as follows:

w+=LTD[(Tₖ−T₄)]+LTD[(Tₖ−T₃)], (Eqn. 10)

where Tₖ={T₆,T₇}.

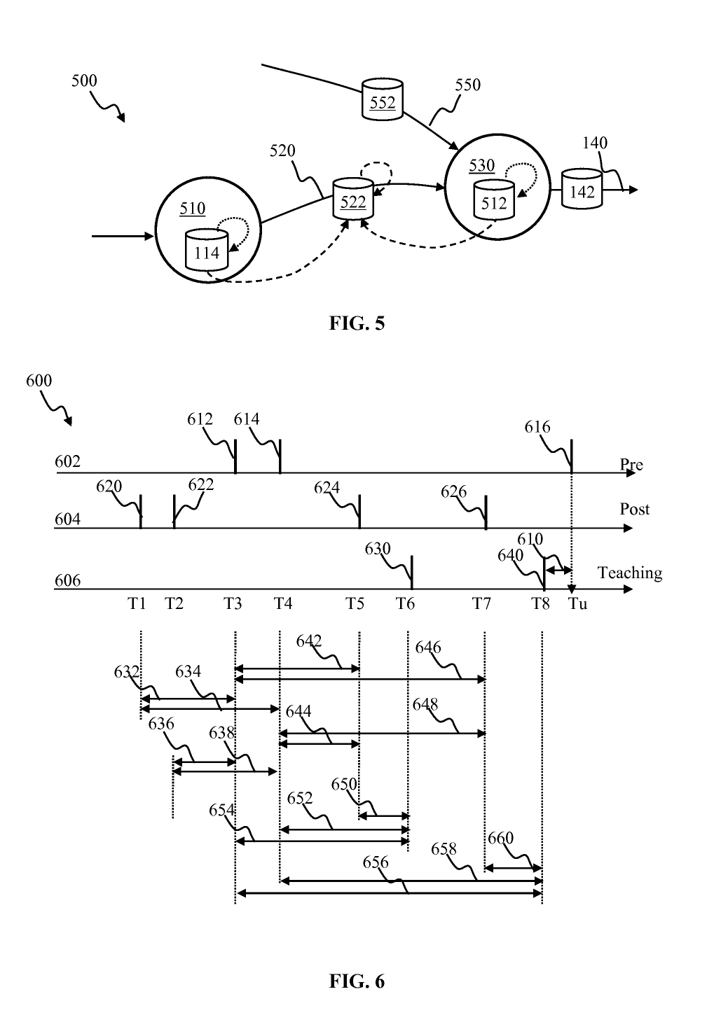

In some implementations of reinforcement learning, spiking network (e.g., the network 500 shown in FIG. 5), may be configured to receive an external input. As shown in FIG. 5, a connection 520 may be configured to provide sensory input to the unit 530. The connection 520 may be characterized by an efficacy (e.g., a weight) that may be stored in the connection memory 522.

In some implementations of signal processing and/or robotics, the term sensory input may be used to inputs characterizing an environment external to the robot and/or signal processing apparatus. Such inputs may include, for example, a stream of raw sensor data (e.g., proximity, inertial, terrain imaging, and/or other raw sensor data) and/or preprocessed data (e.g., velocity, extracted from accelerometers, distance to obstacle, positions, and/or other preprocessed data), a target navigation trajectory, for example, in order to predict future state of the robot on the basis of current state and the target trajectory of motion. In some implementations, such as those involving object recognition, the sensory input may comprise an array of pixel values (e.g., RGB, CMYK, HSV, HSL, grayscale, and/or other pixel values) in the input image, or preprocessed data (e.g., levels of activations of Gabor filters for face recognition, contours, and/or other preprocessed data). The sensory input may be utilized in order to directly modify excitability of network units (e.g., via Eqn. 2). An excitatory sensory input may increase unit excitability, while an inhibitory input may decrease unit excitability.

In one or more implementations, the training or teaching input into a network may be used to describe an input signal that may be configured based on a performance characteristic associated with the network operation. The performance characteristic may be configured, for example, based on a deviation between the target trajectory and actual trajectory of a robot, and/or other performance measures described herein. In some implementations, teaching/training input may be provided by an external agent, e.g., a human user and/or a computerized controller, as described, for example, in U.S. patent application Ser. No. 13/918,338, filed Jun. 14, 2013 and entitled “ROBOTIC TRAINING APPARATUS AND METHODS”, the foregoing being incorporated herein by reference in its entirety. In one or more implementations, the training/teaching input may comprise pre-processed (e.g., threholded) sensory input, e.g., when distance to an obstacle as reported by a proximity sensor falls below a threshold, a negative reinforcement signal may be generated. The training/teaching input may not be utilized in order to modify unit excitability directly (e.g., using Eqn. 2), but may rather be used to adjust one or more parameters of the learning process, e.g., the learning rate as described in U.S. patent application Ser. No. 13/489,280, filed Jun. 5, 2013 and entitled “APPARATUS AND METHODS FOR REINFORCEMENT LEARNING IN ARTIFICIAL NEURAL NETWORKS”, the foregoing being incorporated herein by reference in its entirety. The input via the connection 550 may comprise training input. In some implementations, the training input via the connection 550 may comprise a reinforcement signal configured to aid operation of the network 500 (e.g., via synaptic adaptation) by modifying its control parameters in order to improve the control rules so as to minimize, for example, performance measure associated with the controller performance. The reinforcement signal may comprises two or more states:
(i) a base state (e.g., zero reinforcement, signified, for example, by absence of signal activity on the respective input channel, zero value in of register or variable and/or other approaches). Zero reinforcement state may correspond, for example, to periods when network activity has not arrived at an outcome, e.g., the robotic arm is moving towards the desired target; or when the performance of the system does not change or is precisely as predicted by the internal performance predictor (as for example described in co-owned U.S. patent application Ser. No. 13/238,932 filed Sep. 21, 2011, and entitled “ADAPTIVE CRITIC APPARATUS AND METHODS” incorporated supra); and
(ii) first reinforcement state (e.g., positive reinforcement, signified for example by a positive amplitude pulse of voltage or current, binary flag value of one, a variable value of one, and/or other.). Positive reinforcement is provided when the network operates in accordance with the desired signal, e.g., the robotic arm has reached the desired target, or when the network performance is better than predicted by the performance predictor, as described for example in co-owned U.S. patent application Ser. No. 13/238,932, referenced supra.

In one or more implementations, the reinforcement signal may further comprise a third reinforcement state (e.g., negative reinforcement, signified, for example, by a negative amplitude pulse of voltage or current, a variable value of less than one (e.g., −1, 0.5), and/or manifestations of negative reinforcement). Negative reinforcement may be provided when the network does not operate in accordance with the desired signal (e.g., the robotic arm has reached wrong target, and/or when the network performance is worse than predicted or required).

In some implementations of spiking networks, positive (r⁺) and negative (r⁻) reinforcement signal spike streams may be expressed as:

r⁺(t)=Σᵢδ(t−tᵢ⁺),r⁻(t)=Σᵢδ(t−tᵢ⁻), (Eqn. 11)

where tᵢ⁺, tᵢ⁻ are configured based on spike time(s) associated with positive/negative reinforcement (also referred to as reward/punishment), respectively. In some implementations of supervised learning, a supervisory spike may be used to trigger neuron post-synaptic response.

Reinforcement signal (e.g., of Eqn. 11) may be utilized during learning in order to indicate to the network (e.g., 500 in FIG. 5) as to whether its performance is consistent with learning objective(s). In some implementations, performance consistency may be determined based on a performance function, as described, e.g., in or U.S. patent application Ser. No. 13/487,499, filed Jun. 4, 2012 and entitled “STOCHASTIC APPARATUS AND METHODS FOR IMPLEMENTING GENERALIZED LEARNING RULES”, and/or U.S. patent application Ser. No. 13/554,980 filed Jul. 20, 2012, and entitled “APPARATUS AND METHODS FOR REINFORCEMENT LEARNING IN LARGE POPULATIONS OF ARTIFICIAL SPIKING NEURONS”, each of the foregoing being incorporated by reference in its entirety. As described in the above-referenced applications, the performance consistency may be determined based on an error measure between network actual output (e.g., actual position of a rover performing a target approach) and network target output (e.g., the position of a target and/or target approach trajectory for the rover). Positive reinforcement (e.g., a reward spike) may be utilized based on the current performance approaching the target trajectory; negative reinforcement (e.g., a punishment spike) may be utilized based on the current performance departing from the target trajectory).

In one or more implementations (not shown), reward/punishment signals may be provided by two teaching connections, characterized by respective weights. Positive/negative reinforcement (e.g., reward/punishment) weights may be configured at constant values (e.g., {1, −1}, {1, 0}, {½, −½}) or vary during learning. In some implementations, a network (e.g., 500 in FIG. 5) may receive multiple teaching signals (e.g., via multiple connections 550 and/or multiple pairs of reward/punishment connections).

It will be appreciated by those skilled in the arts that other reinforcement implementations may be used with the network 500 of FIG. 5, such as for example use of two individual connections 550 with one providing positive reinforcement and one providing negative reinforcement indicators, a bi-state or tri-state logic, integer, or floating point register, and/or other approaches. Moreover, reinforcement (including negative reinforcement) may be implemented in a graduated and/or modulated fashion; e.g., increasing levels of negative or positive reinforcement based on the level of “inconsistency”, increasing or decreasing frequency of application of the reinforcement, in some implementations.

Teaching connection memory (e.g., 552) may be used to store efficacy for individual teaching signals. Teaching efficacy may be pre-selected and/or adaptively configured during learning. By way of illustration, a garbage collecting robot may be configured to receive the following teaching signals: reward signal for collecting a piece of refuse; a punishment signal for bumping into objects; and a reward signal for approaching a target area (e.g., charging station). Weights of individual teaching signals may be initially selected as W={0.3, −0.5, 0.2}. Weight values may be adjusted during learning based on robot's performance (e.g., number of pieces of refuse collected, number of collisions, cleaning time, and/or other information associated with the robot's performance).

In some implementations of reinforcement learning, an external signal (e.g., reinforcement spike) may cause a neuron to enter an exploratory regime. In some implementations, a neuron may enter an exploratory regime by increasing synaptic weights for a short period of time.

Units and/or synapses of the network 500 comprising teaching input may be operated in accordance with one or more unit update/synapse rules adapted to take into account the teaching input.

Unit update rule of the unit 530 may be configured to perform one or more of the following: accumulates teaching input in accordance with an accumulation method, determine an effective reward/punishment (reinforcement); and/or cache (at the time of teaching spike arrival): arrival time, value of the teaching spike (e.g., reward/punishment), and/or the effective reinforcement. In some implementations, the teaching signal accumulation method may comprise any applicable formulation, e.g., cumulative sum, average, percentile (e.g., median), sliding temporal average, weighted running mean (e.g., exponentially weighted moving average), and/or other formulations.

Connections 520 and 550 in FIG. 5 may comprise different connection types characterized by respective update and delivery rules. The connection 520 may be characterized by the spike delivery rule of Eqn. 2. The connection 550 may be characterized by the spike delivery rule configured as follows:

post.reward+=w, (Eqn. 12)

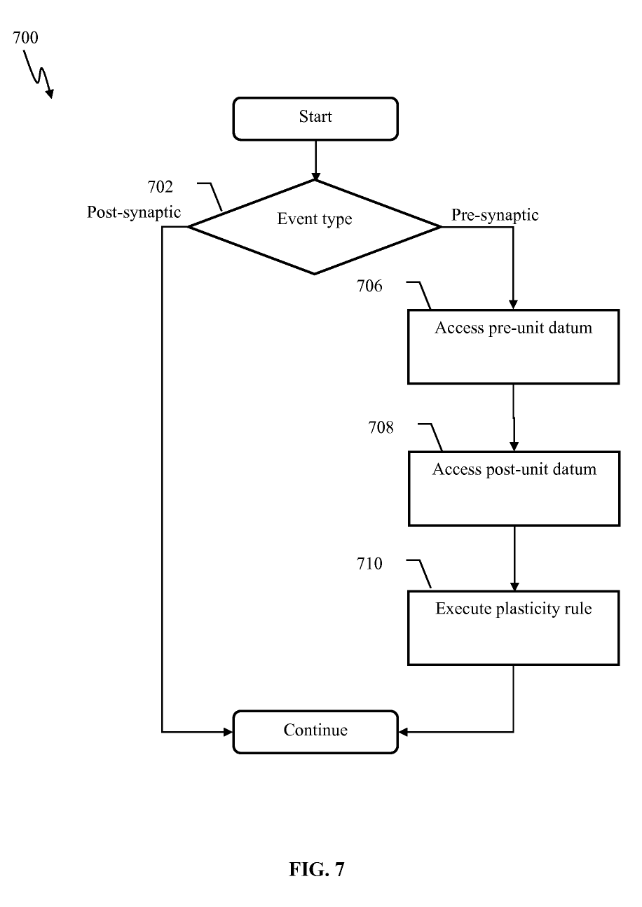

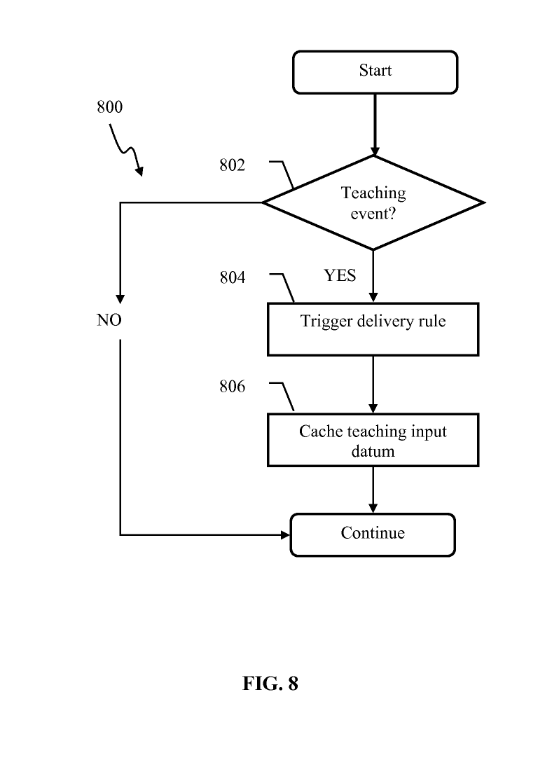

The connection 520 may be characterized by the plasticity rule configured to implement connection efficacy update. The efficacy update may be configured based on timing of pre-synaptic/post-synaptic events, teaching signal time, and/or effective reinforcement, for example, as described in detail below with respect to FIG. 6.

FIG. 6 depicts a timing diagram for implementing all-to-all reward-based plasticity in a spiking neuron network, e.g., the network of FIG. 5 in accordance with one or more implementations. The traces 602, 604, 606 in the diagram 600 of FIG. 6 denote pre-synaptic, post-synaptic unit, and teaching signal activity, respectively, as a function of time. In some implementations, plasticity rule execution may comprise adjusting efficacy of a connection (e.g., the connection 520 in FIG. 5). The pre-synaptic activity in FIG. 6 may comprise spikes 612, 614, 616, generated by the unit 510 in FIG. 5; the post-synaptic activity may comprise spikes 620, 622, 624, 626 generated by the unit 530 in FIG. 5; the teaching activity may comprise spikes 630, 640, e.g., delivered by the connection 550 in FIG. 5.

In one or more implementations illustrated in FIG. 6, the synaptic efficacy update (e.g., of the synapse 520 connecting the pre unit 510 to the post unit 530 in FIG. 5) may be triggered based on a pre-synaptic event occurring subsequent to a teaching input. As shown in FIG. 6, the synaptic efficacy update may be triggered by the pre-event 616 occurring at time Tu (a time interval 610) subsequent to the teaching spike 640 occurring at time T₈.

Although the update (e.g., modification of connection efficacy) may be delayed until a post-synaptic event (e.g., 616 in FIG. 6), a network configured with the reward-based all-to-all plasticity methodology described with respect to FIG. 6 may automatically effectuate connection updates without explicit intervention of a user and/or a teacher subsequent to the teaching spike transmission.

Magnitude of efficacy changes associated with the plasticity rule of FIG. 6 may be configured based on the relative timing between individual post-synaptic events 620, 622, 624, 626, pre-synaptic events 612, 614, and teaching input events 630, 640 in FIG. 3.

Reward-based plasticity modification (e.g., as shown in FIG. 6) may comprise the following portions:
1. LTP due to the post-synaptic event 624 at time T₅ and characterized by the intervals 642, 644;
2. LTD due to the post-synaptic events 620, 622 at times T₁, T₂ and characterized by the intervals 632, 634 and 636, 638, respectively; and
3. LTP due to the post-synaptic event 626 at time T₇ and characterized by the intervals 646, 648.

Magnitude of connection efficacy changes (e.g., potentiation/depression) may be configured based on timing between: (i) pre-post events, as indicated by arrows 632, 634, 636, 638, 642, 644, 646, 648 in FIG. 6; (ii) pre-synaptic events and teaching input, as indicated by arrows 652 654, 656, 658; and (iii) post-synaptic events and teaching input, as indicated by arrows 650, 660.

In some implementations of reward-based STDP, efficacy of a connection (e.g., 520 in FIG. 5) of the network 500 operable in accordance with the timing diagram 600 of FIG. 6 may be modified as follows:

w+=Wᵣ₁+Wᵣ₂, (Eqn. 13)

Wᵣ₁=LTPᵣ₁+LTDᵣ₁ (Eqn. 14)

LTPᵣ₁=D(ΣLTP[(T₅)],T₆−T₅)F(r(T₆)) (Eqn. 15)

LTDᵣ₁=[D(ΣLTD[(T₃)],T₆−T₃)+D(ΣLTD[(T₄)],T₆−T₄)]F(r(T₆)) (Eqn. 16)

Wᵣ₂=LTPᵣ₂+LTDᵣ₂ (Eqn. 17)

LTPᵣ₂=[D(ΣLTP[(T₅)],T₈−T₅)+D(ΣLTP[(T₅)],T₈−T₅)]F(r(T₈) (Eqn. 18)

LTDᵣ₂=[D(ΣLTD[(T₃)],T₈−T₃)+D(ΣLTD[(T₄)],T₈−T₄)]F(r(T₈)) (Eqn. 19)

where:
Wᵣ₁, Wᵣ₂ denote efficacy changes due to the first and the second teaching events (e.g., 630, 640 at times T₆, T₈, respectively);
LTPᵣ₁, LTDᵣ₁ denote efficacy changes due to causal and anti-causal plasticity rule portions responsive to the to the first teaching event 630 at time T₆; and
LTPᵣ₂, LTDᵣ₂ denote efficacy changes due to causal and anti-causal plasticity rule portions responsive to the to the second teaching event 640 at time T₈.

In Eqn. 15, Eqn. 16, Eqn. 18, Eqn. 19 the function D (W₀, Δt) denotes discounting of the efficacy changes due to a time delay between a pre/post event and a teaching event. In some implementations, the efficacy reduction D( ) may be characterized by an exponential decay expressed as:

$$D ( {W}_{0} , Δ t ) = {W}_{0} exp ( - \frac{Δ t}{τ} ) \qquad ( Eqn . 20 )$$

where parameter τ is configured to describe the decay rate. In one or more implementations, the decay rate in Eqn. 20 may be selected from the range between one millisecond and thousands of milliseconds

In Eqn. 15, Eqn. 16, Eqn. 18, Eqn. 19 the function F( ) is configured to modulate efficacy change based on the teaching signal magnitude. In some implementations, the efficacy modulation function may be expressed as a difference between reinforcement value r(t) associated with a given teaching event at time t and an average reinforcement r̅ determined over a time interval dT preceding the event:

F(r(t))=r(t)− r̅. (Eqn. 21)

In some implementations, the average reinforcement r̅ may be referred to as effective reinforcement. It will be appreciated by those skilled in the arts that various other methods of determining effective reinforcement may be utilized including, for example, cumulative sum, percentile (e.g., median), sliding temporal average, weighted running mean (e.g., exponentially weighted moving average), and/or other formulations.

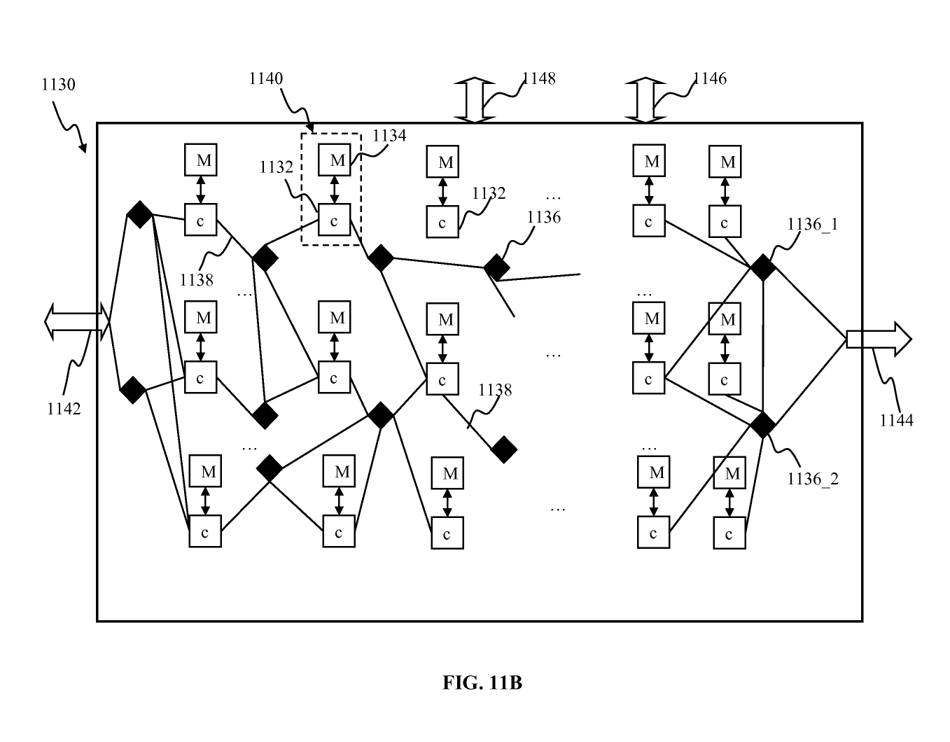

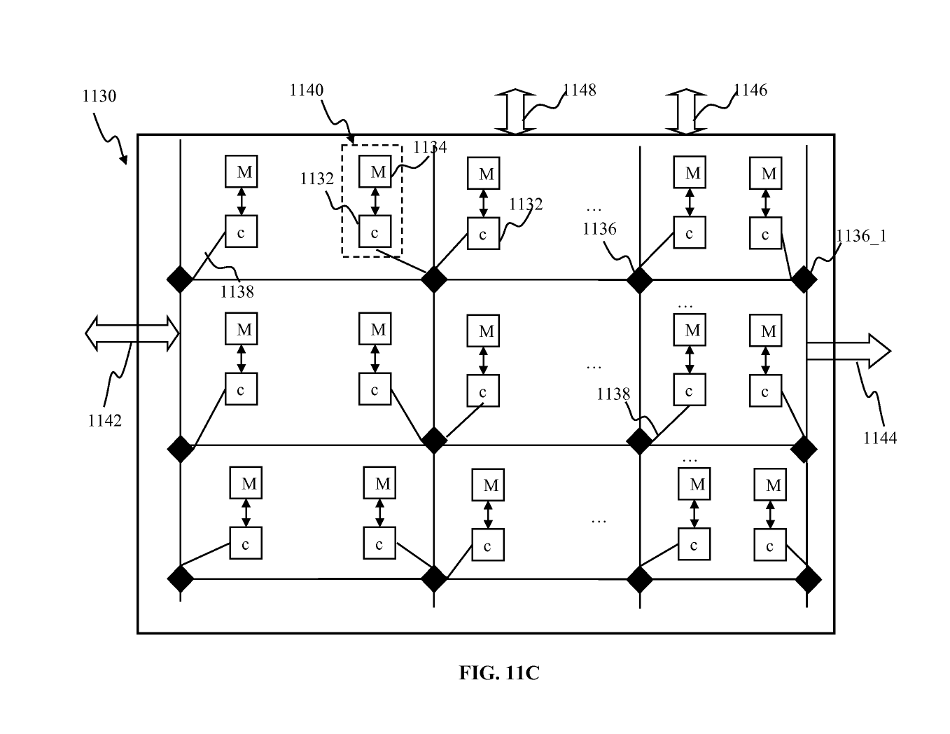

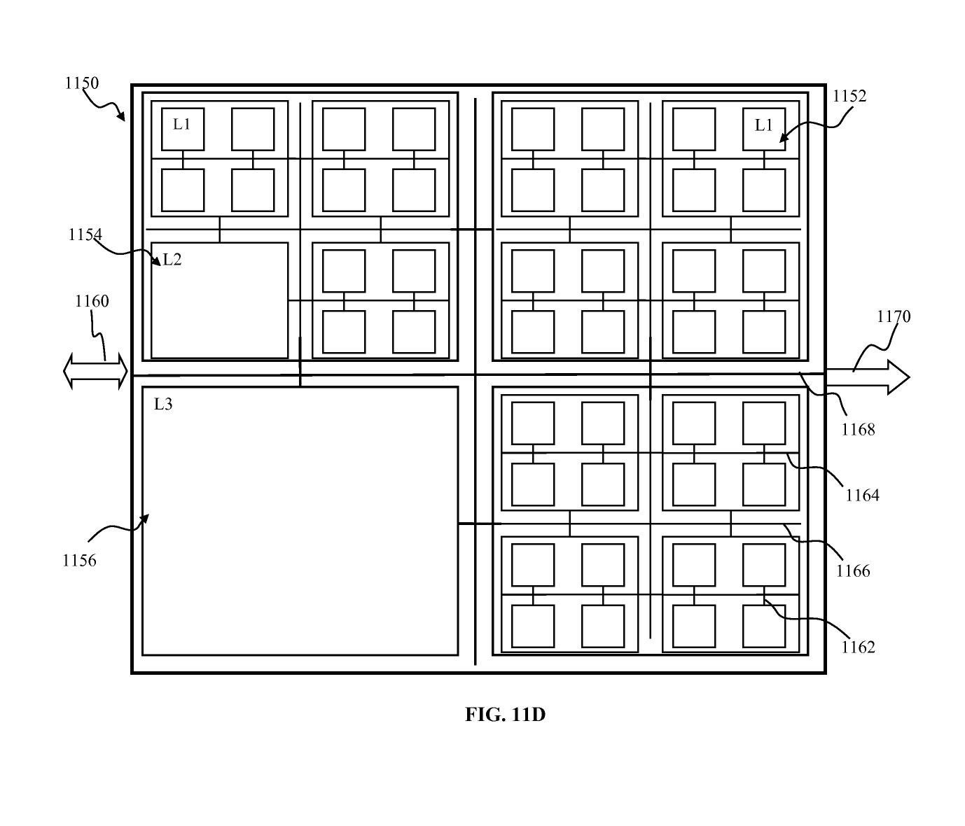

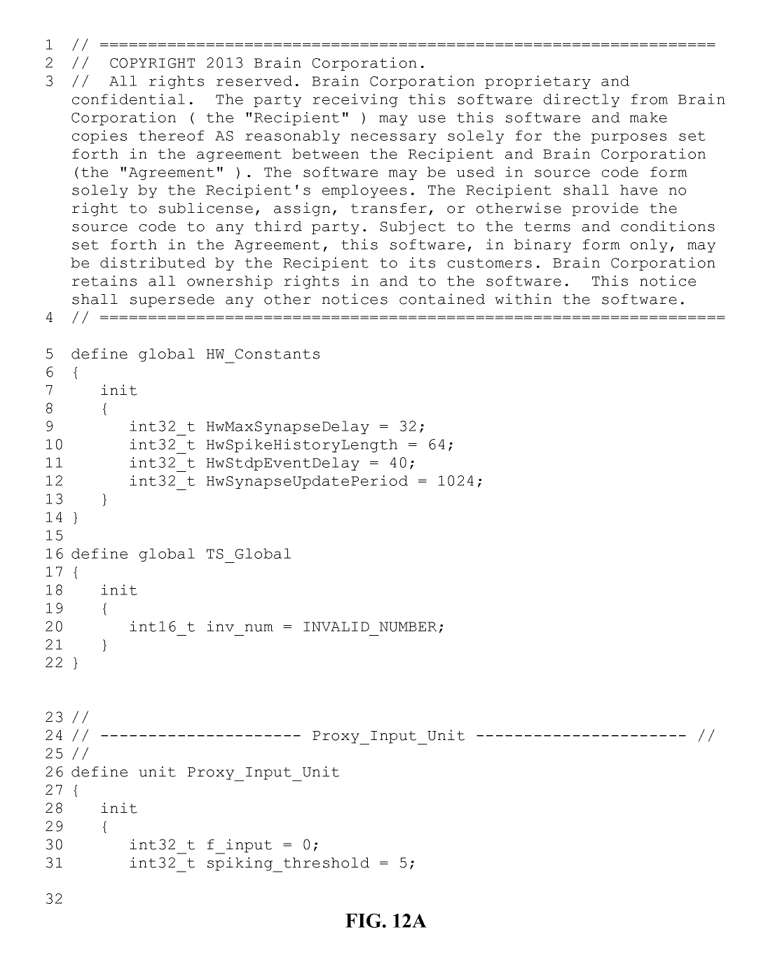

Various computational approaches may be utilized for determining reward-based efficacy changes (e.g., using Eqn. 15-Eqn. 19). In some implementations configured to reduce computational load (e.g., of a processing device 1150 in FIG. 11D) based on occurrence of multiple teaching events, one or more terms (e.g., LTP(T₃), LTP(T₅) in Eqn. 15, Eqn. 16, Eqn. 18, Eqn. 19) may be pre-computed and cached for subsequent use. In one or more implementations configured to reduce memory use, a given term (e.g., Δ₊(T₃), in Eqn. 15, Eqn. 16, Eqn. 18, Eqn. 19) may be computed on an as-needed basis. Various other optimization techniques may be utilized, such as for example computation of basis contributions described in U.S. patent application Ser. No. 13/560,891, filed Jul. 27, 2012, and entitled “APPARATUS AND METHODS FOR EFFICIENT UPDATES IN SPIKING NEURON NETWORKS”, incorporated supra.

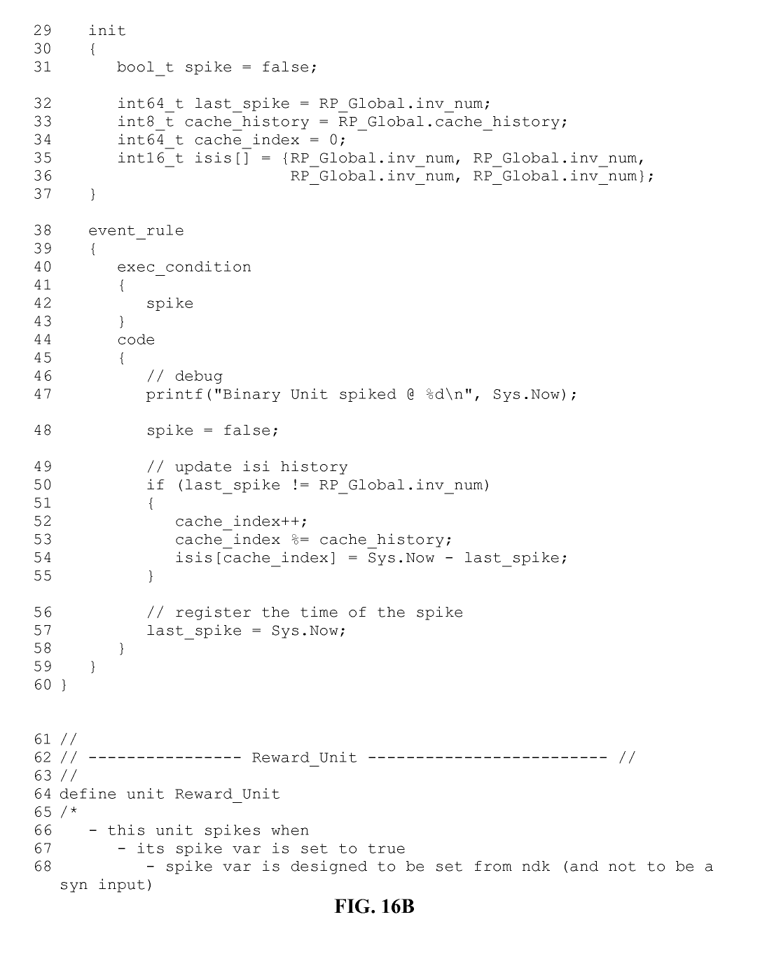

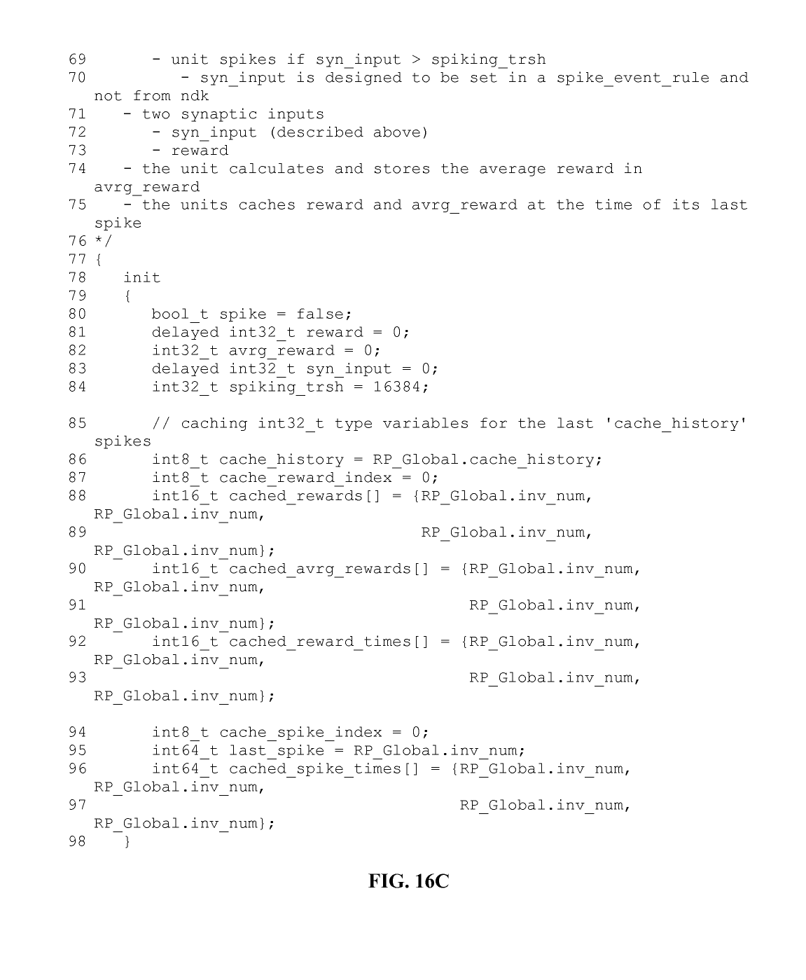

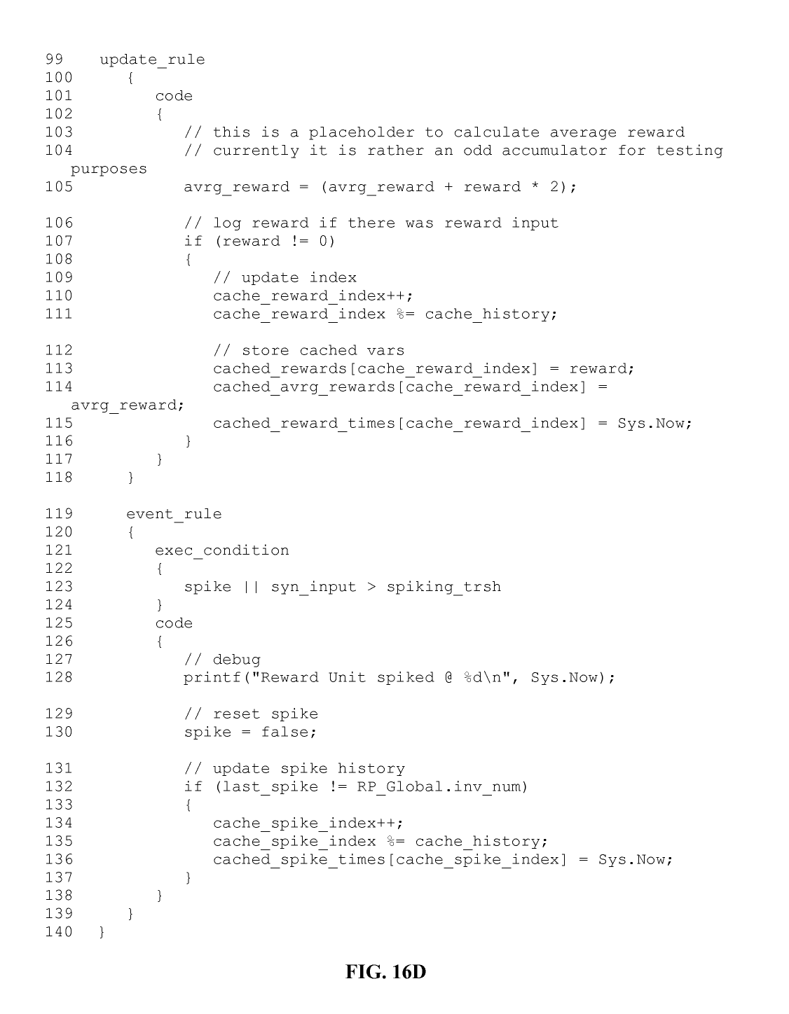

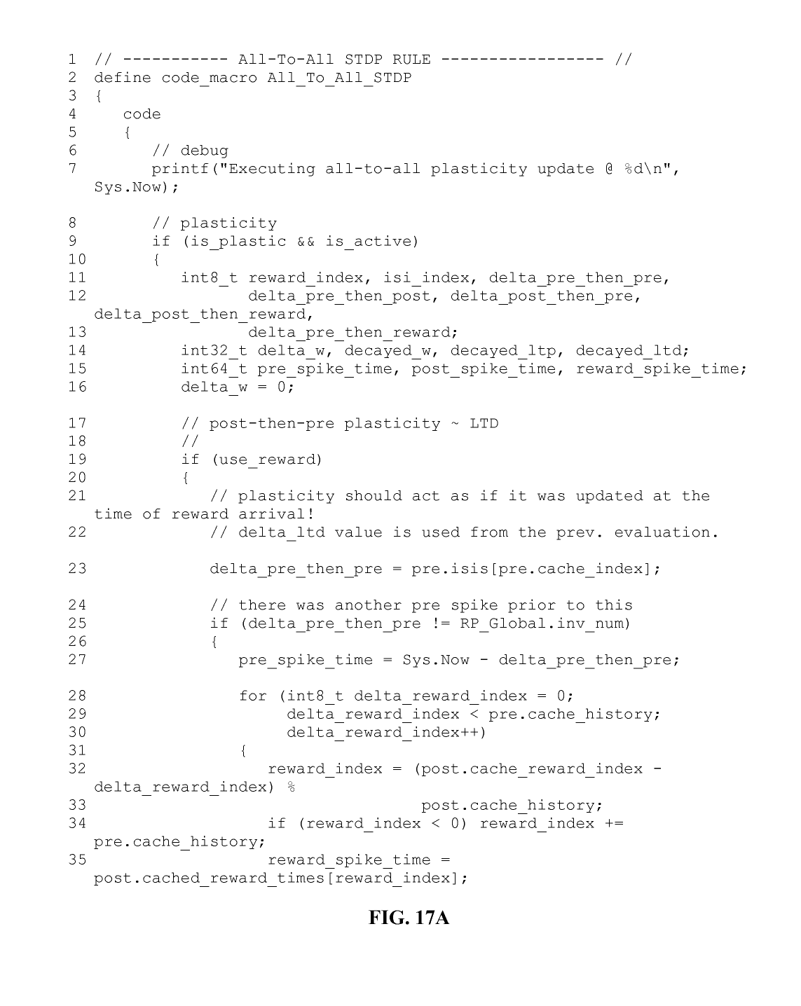

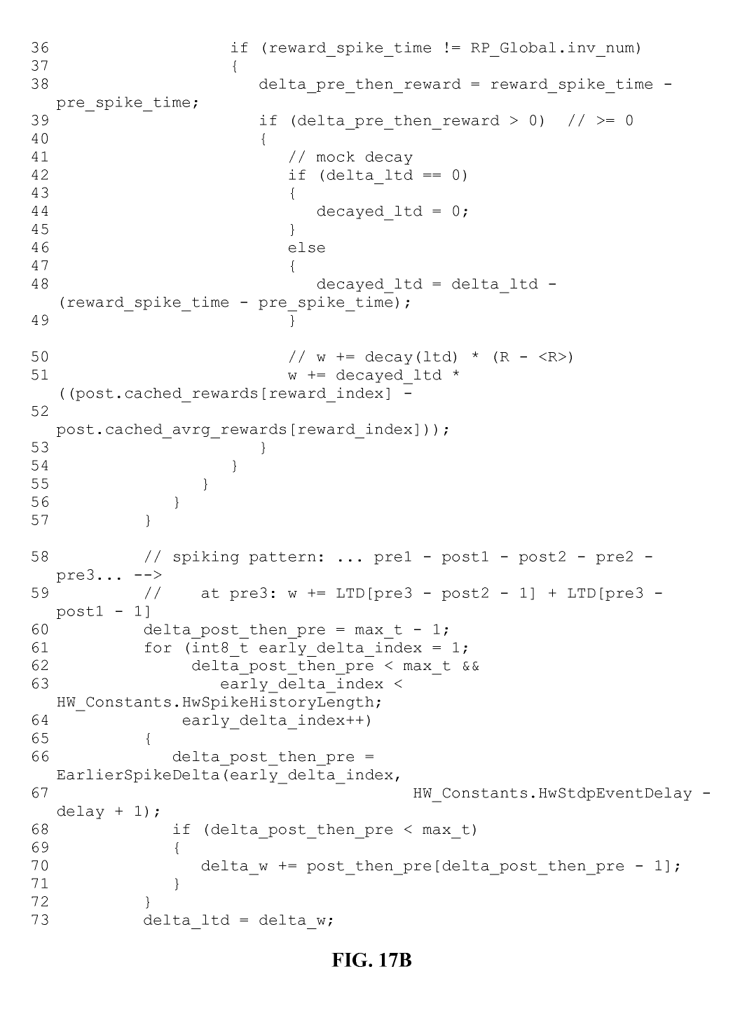

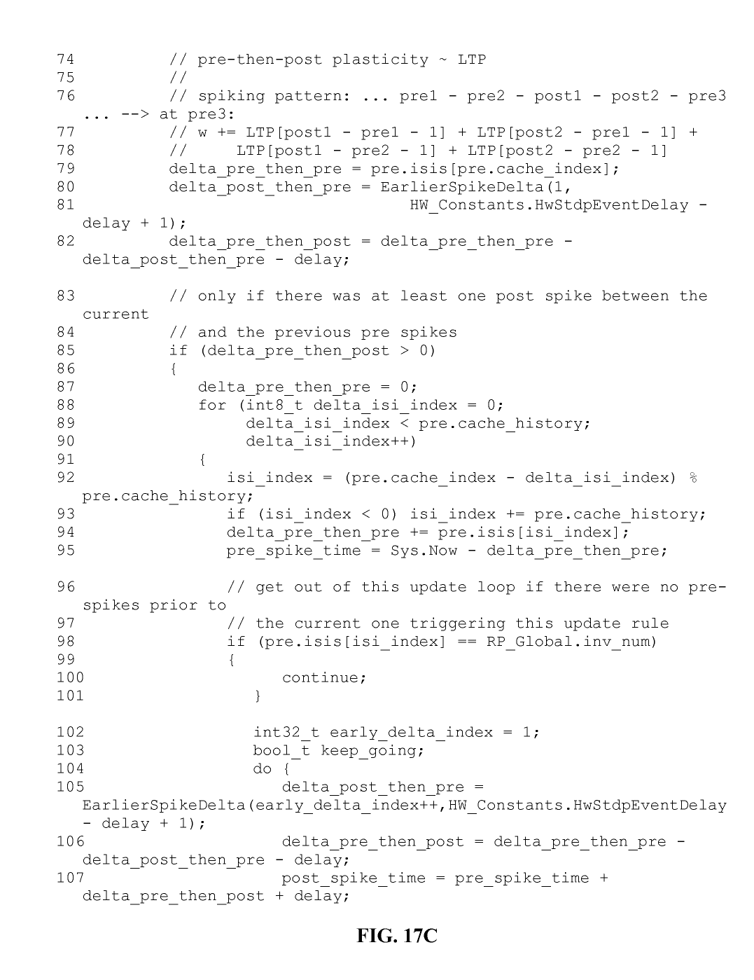

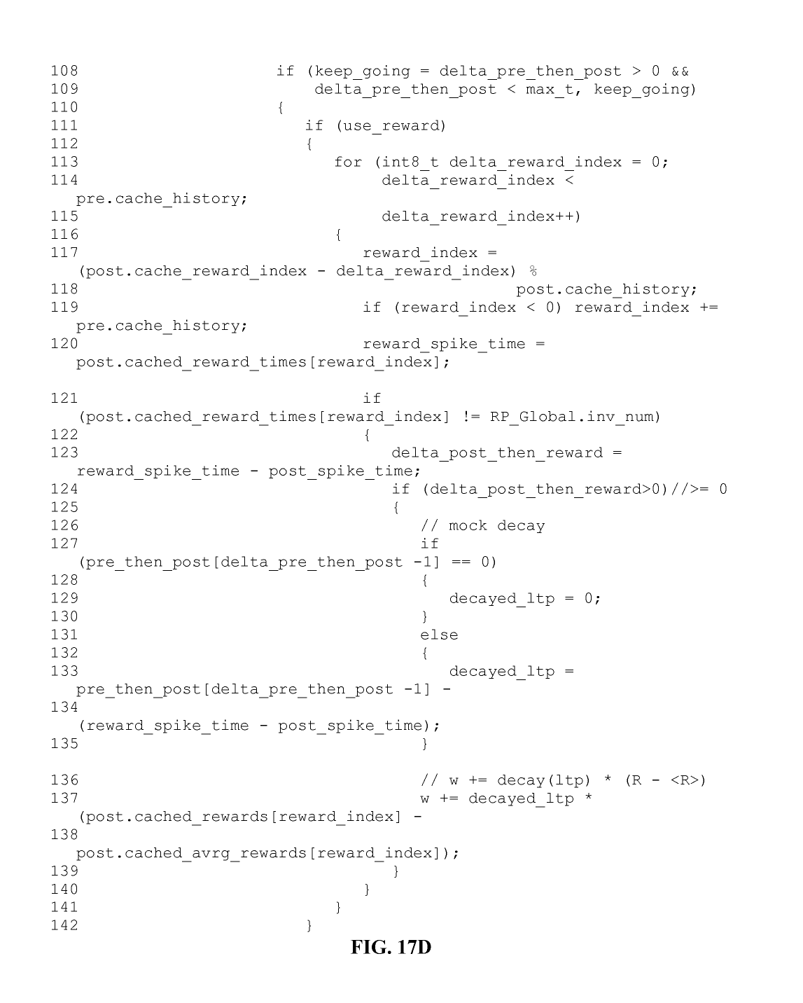

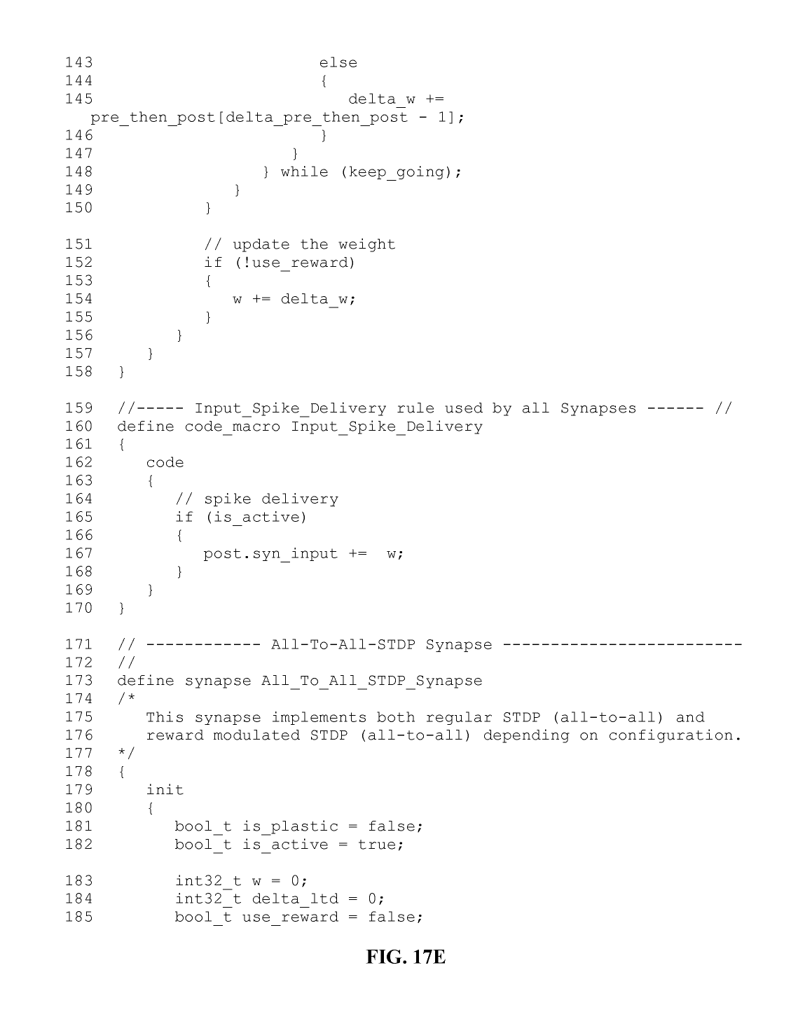

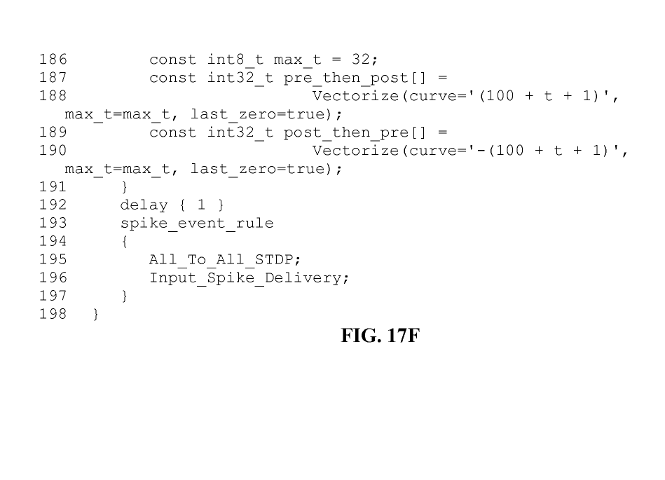

As shown by Eqn. 15-Eqn. 19, efficacy modifications may be configured based on occurrence of one or more teaching input events (e.g., individual events 630, 640 in FIG. 6). The efficacy update may be configured to be triggered by a pre-synaptic event that may occur subsequent to the most recent teaching event (e.g., at time of pre-event 616 that occurs subsequent to teaching input 640). Timing between pre/post activity and the teaching input may be used to discount efficacy change (e.g., using Eqn. 20) that may have occurred in absence of the teaching signal. FIGS. 16A-D-17A-F illustrate an exemplary implementation of all-to-all reward-based plasticity using HLND, in accordance with one or more implementations.

Various STDP mechanisms may be utilized with the efficacy adjustment described herein. In one or more implementations, the STDP mechanism may comprise a rate-modulated plasticity mechanism such as for example those described in commonly owned and co-pending U.S. patent application Ser. No. 13/774,934, entitled “APPARATUS AND METHODS FOR RATE-MODULATED PLASTICITY IN A SPIKING NEURON NETWORK” filed Feb. 22, 2013, and/or a bi-modal plasticity mechanism, for example, such as described in commonly owned and co-pending U.S. patent application Ser. No. 13/763,005, entitled “SPIKING NETWORK APPARATUS AND METHOD WITH BIMODAL SPIKE-TIMING DEPENDENT PLASTICITY” filed Feb. 8, 2013, each of the foregoing being incorporated herein by reference in its entirety.

In one or more implementations, the plasticity mechanism may comprise one or more of: inverse STDP, such as described in commonly owned U.S. patent application Ser. No. 13/465,924, entitled “SPIKING NEURAL NETWORK FEEDBACK APPARATUS AND METHODS” filed May 7, 2012; heterosynaptic plasticity, described in e.g., commonly owned U.S. patent application Ser. No. 13/488,106, entitled “SPIKING NEURON NETWORK APPARATUS AND METHODS” filed Jun. 4, 2012; conditional plasticity described in e.g., commonly owned and co-pending U.S. patent application Ser. No. 13/541,531, entitled “CONDITIONAL PLASTICITY SPIKING NEURON NETWORK APPARATUS AND METHODS” filed Jul. 3, 2012; activity-based plasticity described in e.g., commonly owned and co-pending U.S. patent application Ser. No. 13/660,967, entitled “APPARATUS AND METHODS FOR ACTIVITY-BASED PLASTICITY IN A SPIKING NEURON NETWORK” filed Oct. 25, 2012; and/or plasticity configured to achieve stabilization of neuron firing, described in e.g., commonly owned and co-pending U.S. patent application Ser. No. 13/691,554, entitled “RATE STABILIZATION THROUGH PLASTICITY IN SPIKING NEURON NETWORK” filed Nov. 30, 2012, each of the foregoing incorporated by reference herein in its entirety.

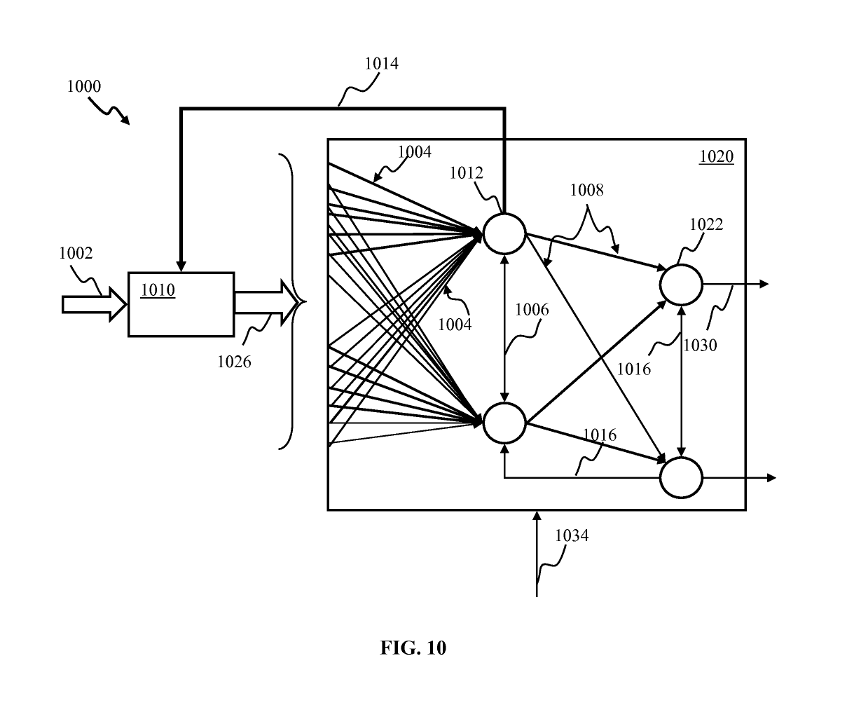

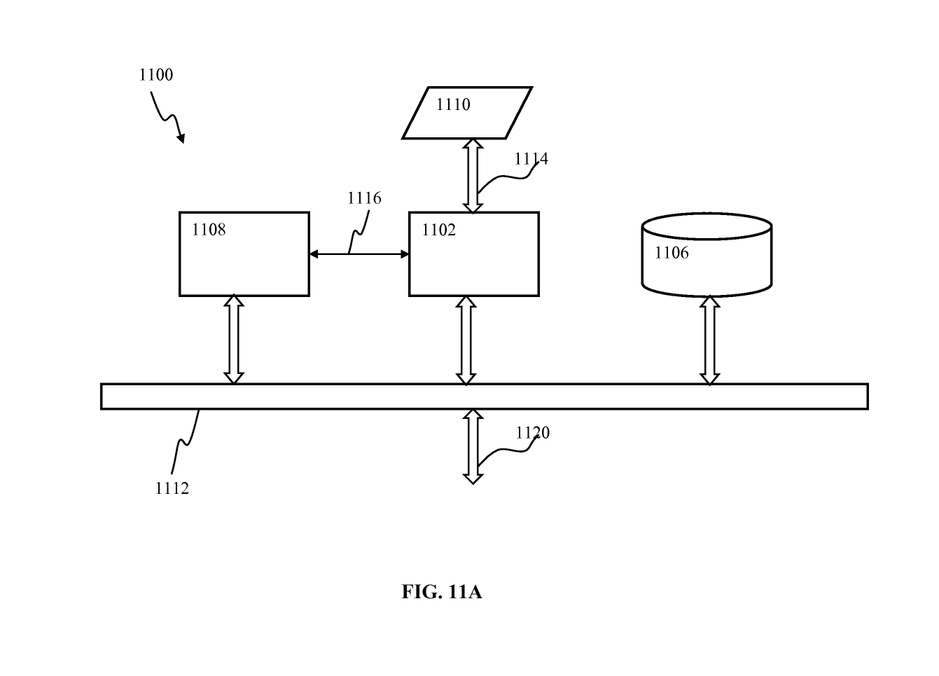

FIGS. 7-9 illustrate exemplary methods of implementing event based plasticity in spiking neuron networks configured in accordance with description of FIGS. 1, 5. In one or more implementations, the operations of methods 700, 800, 900 of FIGS. 7-9, respectively, may be effectuated by a processing apparatus comprising a spiking neuron network such as, for example, the apparatus 1000 of FIG. 10, described in detail below.

FIG. 7 illustrates a method of illustrating event-based synapse update execution in spiking neuron network, in accordance with one or more implementations. Operations of method 700 may be interpreted with respect to the synapse 120 configured to communicate data from the pre-synaptic unit 110 to the post-synaptic unit 130 in FIG. 1A.

At operation 702 a determination may be made as to whether an event has occurred and the type of the event. In some implementations, the event may be based on (i) one or more inputs into a neuron (e.g., inputs via the connection 120, 126 into the neuron 130 in FIG. 1A); and/or a response being generated by the unit (e.g., the unit 130 in FIG. 1A). In some implementations, the event may be based on a timer event configured to effectuate cyclic network updates as prescribed and/or dynamically configured intervals.

Responsive to the determination at operation 702 that a pre-synaptic event has occurred, the method 700 may proceed to operation 706, wherein datum of a pre-synaptic unit (e.g., the unit 110 with respect to connection 120 in FIG. 1A) may be accessed. In some implementations, the pre-synaptic unit datum may comprise time of as pre-synaptic event, unit state (e.g., excitability), and/or other parameters, e.g., firing rate of the unit; and/or a function of unit's activity. The pre-synaptic unit datum may be stored in the unit memory 114 in FIG. 1A. In some implementations, the pre-synaptic unit datum may be provided via payload comprising, for example, average firing rate, timing of spike (e.g., spike generation time by the unit 130), a function of the unit input, and/or other parameters.

At operation 708, a network update may be performed in accordance with the payload. In some implementations, the update may comprise spike generation by the unit; efficacy update of input connections based on a teaching signal; delivery rule modification; post-synaptic rule modification (e.g., as described in U.S. patent application Ser. No. 13/868,944, filed Apr. 23, 2013 and entitled “APPARATUS AND METHODS FOR EVENT-BASED COMMUNICATION IN A SPIKING NEURON NETWORK, incorporates supra); and/or other operations.

At operation 710, plasticity rule may be executed. In one or more implementations, the plasticity rule may comprise one-to-one, one-to-all, all-to-all, e.g., as described above with respect to FIGS. 2-4, and/or other rules.

FIG. 8 illustrates a method of operating a spiking neuron network based on occurrence of a teaching event, in accordance with one or more implementations. Operations of method 800 may be interpreted with respect to the unit 530 configured to receive teaching input via the connection 550 in FIG. 5.

At operation 802, responsive to an occurrence of an event a determination may be made as to whether the event comprises a teaching event. In some implementations, the event may be based on a receipt of a teaching spike (e.g., 630, 640) by the unit 530.

Responsive to a determination at operation 802 the event comprises the teaching event, the method may proceed to operation 804 wherein teaching connection delivery rule may be triggered. In one or more implementations, the delivery rule of operation 804 may be configured in accordance with Eqn. 12.

At operation 806, teaching input data may be cached. In one or more implementations, the teaching input caching operation may comprise determining effective reinforcement (e.g., in accordance with Eqn. 21), and storing, in the unit memory (e.g., the memory 512 of the unit 530 in FIG. 5) time of teaching input occurrence (e.g., time of the teaching input 630, 640 in FIG. 6), the instantaneous reinforcement signal magnitude, and the effective reinforcement signal magnitude.

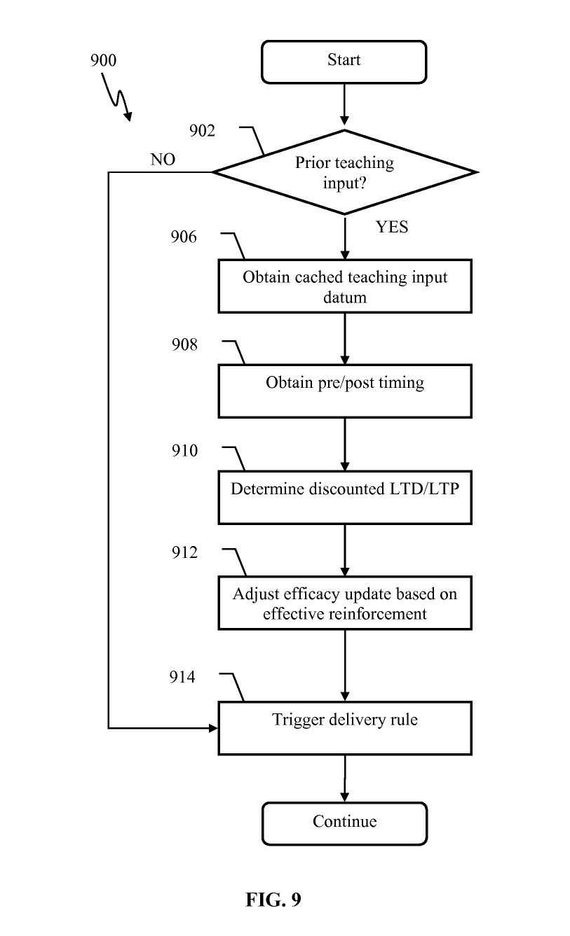

FIG. 9 illustrates a method of implementing reward-based plasticity in the network of FIG. 5, in accordance with one or more implementations. Operations of method 800 may be interpreted with respect to the connection 520 detecting occurrence of a pre-synaptic event associated with the unit 510 in FIG. 5. In one or more implementations, upon generating a response (spike) the unit 510 may notify its outgoing synapses (e.g., 520) of the pre-synaptic event. The notification may comprise a spike, a message, a flag toggle (e.g., register), and/or other methods. Responsive to the occurrence of the pre-synaptic event synapse update may be triggered.

During execution of the synapse update, at operation 902 a determination may be made as to whether a teaching input has occurred within a plasticity window Δt prior to the pre-synaptic event at time Tp. In one or more implementations, operation 902 may be effectuated by the synapse 520 accessing its own memory 522 and accessing memory 512 of the post-synaptic unit 530. In some implementations, operation 902 may be configured based on accessing memory 114 of the pre-synaptic unit 510.

Responsive to a determination at operation 902 that no teaching input has occurred within time interval Tp-Δt, the method 900 may proceed to operation 914 wherein a delivery rule for the synapse may be triggered. In one or more implementations, the delivery rule may be configured in accordance with Eqn. 2.

Responsive to determination at operation 902 that one or more teaching inputs have occurred within time interval Tp-Δt, the method 900 may proceed to operation 906 wherein cached teaching input datum may be obtained. In one or more implementations, the cached input datum may comprise time of teaching input arrival to the post-synaptic unit (e.g., the unit 530, value of the teaching input (e.g., +1 for positive and/or −1 for negative reinforcement), and/or the effective reinforcement. In some implementations, the effective reinforcement may comprise an outcome of operation 806 of the method 800.

At operation 908, timing information of pre-synaptic and post-synaptic events may be obtained. The timing information may comprise time of response generation by the post-synaptic/pre-synaptic units. In some implementations, the generation time may be configured using absolute time (e.g., system time), counter value, delay relative an event (e.g., a prior update), and/or other methods. The retrieval of post-synaptic timing information may be effectuated by the synapse 520 accessing memory 512 of the post-synaptic unit 530. The determination of the pre-synaptic timing information may be effectuated by payload associated with the pre-synaptic spike. In some implementations, the payload may comprise a message and/or a spike characterized by a spike amplitude and/or finite spike duration (spike width). Area associated with spike amplitude and width may be utilized to encode the payload (e.g., greater area may correspond to a large number of bits in the payload.

In one or more implementations, the timing of the pre-synaptic unit may comprise the arrival time of the pre-synaptic unit spike to the post-synaptic unit. The arrival time may be configured based on the generation time of the pre-synaptic unit spike and the delay of the synapse between the pre-synaptic unit and post-synaptic unit.

At operation 910, efficacy adjustment may be determined in accordance with any applicable STDP rules described herein. The STDP efficacy adjustment may be discounted based on a time delay between pre-synaptic/post synaptic events and teaching signal, e.g., using Eqn. 20 as described with respect to FIG. 6, above.

At operation 912, the STDP efficacy adjustment may be modified based on teaching signal. In some implementations, the efficacy modification may be configured based on a function of instantaneous and effective reinforcement, e.g., using Eqn. 15, Eqn. 16, Eqn. 18, Eqn. 19 and Eqn. 21. Subsequently, the method 900 may proceed to operation 914 wherein the delivery rule for the synapse may be triggered.

In some implementations (e.g., as illustrated in FIGS. 12A-13B), the connection plasticity rule may comprise connection delay, and/or transmission probability adjustment.

The parallel network development methodologies described herein may be utilized in a variety of processing apparatus configured to, for example, implement target approach and/or obstacle avoidance by autonomous robotic devices and/or sensory data processing (e.g., object recognition).

One approach to object recognition and/or obstacle avoidance may comprise processing of optical flow using a spiking neural network comprising for example the self-motion cancellation mechanism, such as described, for example, in U.S. patent application Ser. No. 13/689,717, entitled “APPARATUS AND METHODS FOR OBJECT DETECTION VIA OPTICAL FLOW CANCELLATION”, filed Nov. 30, 2012, the foregoing being incorporated herein by reference in its entirety, is shown in FIG. 10. The illustrated processing apparatus 1000 may comprise an input interface configured to receive an input sensory signal 1002. In some implementations, this sensory input may comprise electromagnetic waves (e.g., visible light, IR, UV, and/or other types of electromagnetic waves) entering an imaging sensor array. The imaging sensor array may comprise one or more of retinal ganglion cells RGCs, a charge coupled device (CCD), an active-pixel sensor (APS), and/or other sensors. The input signal may comprise a sequence of images and/or image frames. The sequence of images and/or image frame may be received from a CCD camera via a receiver apparatus and/or downloaded from a file. The image may comprise a two-dimensional matrix of RGB values refreshed at a 25 Hz frame rate. It will be appreciated by those skilled in the arts that the above image parameters are merely exemplary, and many other image representations (e.g., bitmap, CMYK, HSV, grayscale, and/or other representations) and/or frame rates are equally useful with the present disclosure. The apparatus 1000 may be embodied in, for example, an autonomous robotic device.

The apparatus 1000 may comprise an encoder 1010 configured to transform (e.g., encode) the input signal 1002 into an encoded signal 1026. In some implementations, the encoded signal may comprise a plurality of pulses (also referred to as a group of pulses) configured to represent to optical flow due to one or more objects in the vicinity of the robotic device

The encoder 1010 may comprise one or more spiking neurons. One or more of the spiking neurons of the block 1010 may be configured to encode motion input 1004. One or more of the spiking neurons of the block 1010 may be configured to encode input 1002 into optical flow, as described in U.S. patent application Ser. No. 13/689,717, entitled “APPARATUS AND METHODS FOR OBJECT DETECTION VIA OPTICAL FLOW CANCELLATION”, filed Nov. 30, 2012, incorporated supra.

The encoded signal 1026 may be communicated from the encoder 1010 via multiple connections (also referred to as transmission channels, communication channels, or synaptic connections) 1004 to one or more neuronal units (also referred to as the detectors) 1022.

Although only two detectors are shown in the FIG. 10 for clarity, it will be appreciated that the encoder 1026 may be coupled to any number of detector units that is compatible with the detection apparatus hardware and software limitations. Furthermore, a single detector unit may be coupled to any practical number of encoders.

In various implementations, individual detectors 1012 may contain logic (which may be implemented as a software code, hardware logic, or a combination of thereof) configured to recognize a predetermined pattern of pulses in the encoded signal 1026 to produce detection signals transmitted over communication channels 1008 (with an appropriate latency) that may propagate with different conduction delays to the detectors 1022. Such recognition may include one or more mechanisms described in U.S. patent application Ser. No. 12/869,573, filed Aug. 26, 2010 and entitled “SYSTEMS AND METHODS FOR INVARIANT PULSE LATENCY CODING”, U.S. patent application Ser. No. 12/869,583, filed Aug. 26, 2010, entitled “INVARIANT PULSE LATENCY CODING SYSTEMS AND METHODS”, U.S. patent application Ser. No. 13/117,048, filed May 26, 2011 and entitled “APPARATUS AND METHODS FOR POLYCHRONOUS ENCODING AND MULTIPLEXING IN NEURONAL PROSTHETIC DEVICES”, U.S. patent application Ser. No. 13/152,084, filed Jun. 2, 2011, entitled “APPARATUS AND METHODS FOR PULSE-CODE INVARIANT OBJECT RECOGNITION”, each of the foregoing incorporated herein by reference in its entirety.

In some implementations, the detection signals may be delivered to a next layer of detectors 1022 for recognition of complex object features and objects, similar to the exemplary implementation described in commonly owned and co-pending U.S. patent application Ser. No. 13/152,084, filed Jun. 2, 2011, entitled “APPARATUS AND METHODS FOR PULSE-CODE INVARIANT OBJECT RECOGNITION”, incorporated supra. In such implementations, individual subsequent layers of detectors may be configured to receive signals (e.g., via connections 1008) from the previous detector layer, and to detect more complex features and objects (as compared to the features detected by the preceding detector layer). For example, a bank of edge detectors may be followed by a bank of bar detectors, followed by a bank of corner detectors and so on, thereby enabling recognition of one or more letters of an alphabet by the apparatus.

Individual detectors 1022 may output detection (post-synaptic) signals on communication channels 1030 (with an appropriate latency) that may propagate with different conduction delays to other portions of processing apparatus 1000. In some implementations, the detector cascade shown in FIG. 10 may contain any practical number of detector units and detector banks determined, inter alia, by the software/hardware resources of the detection apparatus and complexity of the objects being detected.

The exemplary sensory processing apparatus 1000 illustrated in FIG. 10 may further comprise one or more lateral connections 1006, 1016, configured to provide information about activity of neighboring neurons to one another.

In some implementations, the apparatus 1000 may comprise feedback connections 1014, 1016, configured to communicate context information from detectors within one hierarchy layer to previous layers, as illustrated by the feedback connection 1016 in FIG. 10. In some implementations, the feedback connection 1014 may be configured to provide feedback to the encoder 1010 thereby facilitating sensory input encoding, as described in detail in commonly owned and co-pending U.S. patent application Ser. No. 13/152,084, filed Jun. 2, 2011, entitled “APPARATUS AND METHODS FOR PULSE-CODE INVARIANT OBJECT RECOGNITION”, incorporated supra.

Output of the processing apparatus 1000 may be provided via one or more connections 1030.

In some implementations, the units 1012, 1022, and the connections 1004, 1008, 1006, 1016, 1030 may comprise a spiking neuron network operable in accordance with the event-based plasticity methodology described herein. The network 1020 may be configured to implement, inter alia, one or more of one-to-one, one-to-all, and/or all-to-all plasticity rules, e.g., as described above with respect to FIGS. 2-4 and/or FIG. 7.

In some implementations, network 1020 may be operable based on a teaching signal 1034. The teaching signal may provide reward/punishment to units of the network 1020. Operation of the network 1020 may be configured based on a reward-based plasticity mechanism, e.g., as described above with respect to FIG. 6, and/or FIGS. 8-9.

Various exemplary computerized apparatus configured to code configured to implement event-based plasticity development methodology set forth herein are now described with respect to FIGS. 11A-11D.

A computerized neuromorphic processing system, for implementing e.g., the apparatus 1000 of FIG. 10 described, supra, is illustrated in FIG. 11A. The computerized system 1100 of FIG. 11A may comprise an input device 1110, such as, for example, an image sensor and/or digital image interface. The input interface 1110 may be coupled to the processing block (e.g., a single or multi-processor block) via the input communication interface 1114. In some implementations, the interface 1114 may comprise a wireless interface (cellular wireless, Wi-Fi, Bluetooth, etc.) that enables data transfer to the processor 1102 from a remote I/O interface.

The system 1100 further may comprise a random access memory (RAM) 1108, configured to store neuronal states and connection parameters and to facilitate synaptic updates. In some implementations, synaptic updates may be performed according to the description provided in, for example, in U.S. patent application Ser. No. 13/239,255 filed Sep. 21, 2011, entitled “APPARATUS AND METHODS FOR SYNAPTIC UPDATE IN A PULSE-CODED NETWORK”, incorporated by reference, supra

In some implementations, the memory 1108 may be coupled to the processor 1102 via a direct connection 1116 (e.g., memory bus). The memory 1108 may also be coupled to the processor 1102 via a high-speed processor bus 1112.

The system 1100 may comprise a nonvolatile storage device 1106. The nonvolatile storage device 1106 may comprise, inter alia, computer readable instructions configured to implement various aspects of spiking neuronal network operation. Examples of various aspects of spiking neuronal network operation may include one or more of sensory input encoding, connection plasticity, operation model of neurons, learning rule evaluation, other operations, and/or other aspects. The nonvolatile storage 1106 may be used to store state information of the neurons and connections when, for example, saving and/or loading network state snapshot, implementing context switching, saving current network configuration, and/or performing other operations. The current network configuration may include one or more of connection weights, update rules, neuronal states, learning rules, and/or other parameters.

In some implementations, the computerized apparatus 1100 may be coupled to one or more of an external processing device, a storage device, an input device, and/or other devices via an I/O interface 1120. The I/O interface 1120 may include one or more of a computer I/O bus (PCI-E), wired (e.g., Ethernet) or wireless (e.g., Wi-Fi) network connection, and/or other I/O interfaces.

In some implementations, the input/output (I/O) interface 1120 may comprise a speech input (e.g., a microphone) and a speech recognition module configured to receive and recognize user commands.

It will be appreciated by those skilled in the arts that various processing devices may be used with computerized system 1100, including but not limited to, a single core/multicore CPU, DSP, FPGA, GPU, ASIC, combinations thereof, and/or other processing entities (e.g., computing clusters and/or cloud computing services). Various user input/output interfaces may be similarly applicable to implementations of the invention including, for example, an LCD/LED monitor, touch-screen input and display device, speech input device, stylus, light pen, trackball, and/or other devices.

Referring now to FIG. 11B, one implementation of neuromorphic computerized system configured to implement event-based plasticity mechanism in a spiking network is described in detail. The neuromorphic processing system 1130 of FIG. 11B may comprise a plurality of processing blocks (micro-blocks) 1140. Individual micro cores may comprise a computing logic core 1132 and a memory block 1134. The logic core 1132 may be configured to implement various aspects of neuronal unit operation, such as the unit model (e.g., update rule), and synaptic update rules and/or other tasks relevant to network operation. The memory block may be configured to store, inter alia, neuronal state variables and connection parameters (e.g., weights, delays, I/O mapping) of connections 1138.

The micro-blocks 1140 may be interconnected with one another using connections 1138 and routers 1136. As it is appreciated by those skilled in the arts, the connection layout in FIG. 11B is exemplary, and many other connection implementations (e.g., one to all, all to all, and/or other maps) are compatible with the disclosure.

The neuromorphic apparatus 1130 may be configured to receive input (e.g., visual input) via the interface 1142. In one or more implementations, applicable for example to interfacing with computerized spiking retina, or image array, the apparatus 1130 may provide feedback information via the interface 1142 to facilitate encoding of the input signal.

The neuromorphic apparatus 1130 may be configured to provide output via the interface 1144. Examples of such output may include one or more of an indication of recognized object or a feature, a motor command (e.g., to zoom/pan the image array), and/or other outputs.

The apparatus 1130, in one or more implementations, may interface to external fast response memory (e.g., RAM) via high bandwidth memory interface 1148, thereby enabling storage of intermediate network operational parameters. Examples of intermediate network operational parameters may include one or more of spike timing, neuron state, and/or other parameters. The apparatus 1130 may interface to external memory via lower bandwidth memory interface 1146 to facilitate one or more of program loading, operational mode changes, retargeting, and/or other operations. Network node and connection information for a current task may be saved for future use and flushed. Previously stored network configuration may be loaded in place of the network node and connection information for the current task, as described for example in co-pending and co-owned U.S. patent application Ser. No. 13/487,576 entitled “DYNAMICALLY RECONFIGURABLE STOCHASTIC LEARNING APPARATUS AND METHODS” filed Jun. 4, 2012, incorporated herein by reference in its entirety. External memory may include one or more of a Flash drive, a magnetic drive, and/or other external memory.

FIG. 11C illustrates one or more implementations of shared bus neuromorphic computerized system 1145 comprising micro-blocks 1140, described with respect to FIG. 11B, supra. The system 1145 of FIG. 11C may utilize shared bus 1147, 1149 to interconnect micro-blocks 1140 with one another.

FIG. 11D illustrates one implementation of cell-based neuromorphic computerized system architecture configured to implement efficacy balancing mechanism in a spiking network. The neuromorphic system 1150 may comprise a hierarchy of processing blocks (cells blocks). In some implementations, the lowest level L1 cell 1152 of the apparatus 1150 may comprise logic and memory blocks. The lowest level L1 cell 1152 of the apparatus 1150 may be configured similar to the micro block 1140 of the apparatus shown in FIG. 11B. A number of cell blocks may be arranged in a cluster and may communicate with one another via local interconnects 1162, 1164. Individual clusters may form higher level cell e.g., cell L2, denoted as 1154 in FIG. 11D. Similarly, several L2 clusters may communicate with one another via a second level interconnect 1166 and form a super-cluster L3, denoted as 1156 in FIG. 11D. The super-clusters 1154 may communicate via a third level interconnect 1168 and may form a next level cluster. It will be appreciated by those skilled in the arts that the hierarchical structure of the apparatus 1150, comprising four cells-per-level, is merely one exemplary implementation, and other implementations may comprise more or fewer cells per level, and/or fewer or more levels.

Different cell levels (e.g., L1, L2, L3) of the apparatus 1150 may be configured to perform functionality various levels of complexity. In some implementations, individual L1 cells may process in parallel different portions of the visual input (e.g., encode individual pixel blocks, and/or encode motion signal), with the L2, L3 cells performing progressively higher level functionality (e.g., object detection). Individual ones of L2, L3, cells may perform different aspects of operating a robot with one or more L2/L3 cells processing visual data from a camera, and other L2/L3 cells operating a motor control block for implementing lens motion for tracking an object or performing lens stabilization functions.

The neuromorphic apparatus 1150 may receive input (e.g., visual input) via the interface 1160. In one or more implementations, applicable for example to interfacing with computerized spiking retina, or image array, the apparatus 1150 may provide feedback information via the interface 1160 to facilitate encoding of the input signal.

The neuromorphic apparatus 1150 may provide output via the interface 1170. The output may include one or more of an indication of recognized object or a feature, a motor command, a command to zoom/pan the image array, and/or other outputs. In some implementations, the apparatus 1150 may perform all of the I/O functionality using single I/O block (not shown).

The apparatus 1150, in one or more implementations, may interface to external fast response memory (e.g., RAM) via a high bandwidth memory interface (not shown), thereby enabling storage of intermediate network operational parameters (e.g., spike timing, neuron state, and/or other parameters). In one or more implementations, the apparatus 1150 may interface to external memory via a lower bandwidth memory interface (not shown) to facilitate program loading, operational mode changes, retargeting, and/or other operations. Network node and connection information for a current task may be saved for future use and flushed. Previously stored network configuration may be loaded in place of the network node and connection information for the current task, as described for example in commonly owned and co-pending U.S. patent application Ser. No. 13/487,576, entitled “DYNAMICALLY RECONFIGURABLE STOCHASTIC LEARNING APPARATUS AND METHODS”, incorporated, supra.

In one or more implementations, one or more portions of the apparatus 1150 may be configured to operate one or more learning rules, as described for example in commonly owned and co-pending U.S. patent application Ser. No. 13/487,576 entitled “DYNAMICALLY RECONFIGURABLE STOCHASTIC LEARNING APPARATUS AND METHODS” filed Jun. 4, 2012, incorporated herein by reference in its entirety. In one such implementation, one block (e.g., the L3 block 1156) may be used to process input received via the interface 1160 and to provide a reinforcement signal to another block (e.g., the L2 block 1156) via interval interconnects 1166, 1168.

Event-based plasticity methodology described herein may enable implementations of spiking neuron networks within the constraints of specialized neuromorphic hardware. Constraints of specialized neuromorphic hardware may be configured based of a access mechanism of unit update process to incoming and/or outgoing synapses. In one or more implementations, e.g., shown and described with respect to FIG. 5, a unit event (e.g., pre-synaptic spike) may cause updates of outgoing synapses for that unit.

The principles described herein may also be combined with other mechanisms of data encoding in neural networks, such as those described in commonly owned and co-pending U.S. patent application Ser. No. 13/152,084 entitled APPARATUS AND METHODS FOR PULSE-CODE INVARIANT OBJECT RECOGNITION” filed Jun. 2, 2011, and Ser. No. 13/152,119, Jun. 2, 2011, entitled “SENSORY INPUT PROCESSING APPARATUS AND METHODS”, and Ser. No. 13/152,105 filed on Jun. 2, 2011, and entitled “APPARATUS AND METHODS FOR TEMPORALLY PROXIMATE OBJECT RECOGNITION”, incorporated, supra.

Exemplary implementations of the present disclosure may be useful in a variety of devices including without limitation prosthetic devices, autonomous and robotic apparatus, and other electromechanical devices requiring sensory processing functionality. Examples of such robotic devises include one or more of manufacturing robots (e.g., automotive), military, medical (e.g. processing of microscopy, x-ray, ultrasonography, tomography). Examples of autonomous vehicles include rovers, unmanned air vehicles, underwater vehicles, smart appliances (e.g. ROOMBA®), and/or other robotic devices.

Implementations of the principles of the disclosure may be applicable to video data compression and processing in a wide variety of stationary and portable devices, such as, for example, smart phones, portable communication devices, notebook, netbook and tablet computers, surveillance camera systems, and practically any other computerized device configured to process vision data

In some implementations, portions of the object recognition system may be embodied in a remote server, comprising a computer readable apparatus storing computer executable instructions configured to perform pattern recognition in data streams for various applications, such as scientific, geophysical exploration, surveillance, navigation, data mining (e.g., content-based image retrieval). Myriad other applications exist that will be recognized by those of ordinary skill given the present disclosure.

It will be recognized that while certain aspects of the disclosure may be described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed:

1. A computer-implemented method of operating a spiking neuron sensory input processing apparatus, the method being performed by one or more processors configured to execute computer program modules, the method comprising:
operating, using one or more processors, the spiking neuron in accordance with a unit process characterized by an excitability;
updating, using one or more processors, the excitability based on a first sensory spike received via a first connection by the neuron and a first parameter of the first connection;
determining, using one or more processors, a second parameter of the neuron based on a teaching spike received via a second connection by the neuron; and
responsive to a receipt of a second sensory spike via the first connection, determining the first parameter;
wherein the determination of the first parameter is configured based on a value of the second parameter.

2. The method of claim 1, wherein:
the teaching spike occurs subsequent to the first sensory spike and prior to the second sensory spike; and
the neuron is configured to provide an output spike based on the excitability parameter breaching a threshold.

3. The method of claim 2, wherein:
the first parameter comprises an efficacy of the connection, the efficacy being configured to affect the updating of the excitability responsive to receipt of the first spike; and
the determination of the first parameter is configured to affect a probability of the output spike provided by the neuron.

4. The method of claim 2, wherein:
the first parameter comprises an efficacy of the connection, the efficacy being configured to affect the updating of the excitability responsive to receipt of the first spike; and
the determination of the first parameter comprises an increase or decrease of the connection efficacy, the increase or the decrease being configured to advance or delay, respectively, provision of the output spike subsequent to the second sensory spike.

5. The method of claim 2, wherein:
the neuron is characterized by a neuron memory configured to store the excitability value;
the unit process is configured to access the unit memory and to modify the excitability value;
the first connection is configured to be operable in accordance with a first connection process configured to access the first connection memory and the unit memory, the first connection memory being configured to store the first parameter value; and
the second connection is configured to be operable in accordance with a second connection process configured to access the unit memory, to effectuate the determining of the second parameter.

6. The method of claim 5, wherein:
the sensory input is configured to communicate information related to an environment external to the unit process, the sensory input comprising the first and the second sensory spikes;
the teaching spike is configured based on a performance measure associated with the unit process; and
the second parameter is configured based on occurrence time of the teaching spike.

7. The method of claim 6, wherein:
the unit process is configured to provide a target output; and
the performance measure is determined based on a discrepancy between the target output and the output spike.

8. The method of claim 2, wherein:
the determination of the first parameter is characterized by an adjustment magnitude that is configured based on a time interval between the first sensory spike and the output spike; and
a time interval between the output spike and the teaching spike.

9. The method of claim 8, wherein:
responsive to the first sensory spike preceding the output spike, the adjustment magnitude is positive; or
responsive to the first sensory spike following the output spike, the adjustment magnitude is negative.

10. The method of claim 8, wherein the adjustment magnitude determined based on the time interval between the first sensory spike and the output spike is diminished in accordance with the time interval between the output spike and the teaching spike.

11. The method of claim 8, wherein the adjustment magnitude is further configured based on a time interval between the first sensory spike and the output spike.

12. The method of claim 11, wherein the adjustment magnitude is configured to decrease in accordance with the time interval between the first sensory and the teaching spike.

13. The method of claim 8, wherein:
the second connection is configured to be operable in accordance with a second connection process characterized by second connection efficacy; and
the adjustment magnitude determined based on the time interval between the first input spike and the output spike is modified based on the second connection efficacy.

14. The method of claim 13, wherein the modification comprises a multiplicative operation of the second connection efficacy.

15. The method of claim 2, wherein the sensory spike is feed forward and does not depend on the output spike of the neuron.

16. The method of claim 2, wherein the first connection is configured to communicate to the first connection process a timing information associated with occurrence of the first sensory spike via payload comprising two or more bits.

17. A computerized robotic control system, comprising:
a sensor apparatus configured to provide sensory input; and
a control apparatus comprising a spiking neuron network configured to receive the sensory input and to provide a control signal configured to operate a robotic platform in accordance with a target trajectory;
wherein:
the spiking neuron network is configured to be operable in accordance with a reinforcement process configured to determine an efficacy of a first connection configured to communicate the sensory input to a neuron, the efficacy determination being configured based on:
a reinforcement signal provided to the neuron via a connection other than the first connection, the efficacy determination configured comprising;
a first time interval between a first portion of the sensory input and an output being provided by the neuron, the first portion preceding the output;
a second time interval between the first portion of the sensory input and the reinforcement signal;
a third time interval between the output and the reinforcement signal; and
a value associated with the reinforcement signal.

18. The apparatus of claim 17, wherein the value is determined based on a performance measure, the performance measure being determined based on an evaluation of the target trajectory and actual trajectory of the robotic platform, the actual trajectory being obtained based on the control signal, the value being positive responsive to the performance measure being within a threshold, the value being negative responsive to the performance measure being outside the threshold.

19. The apparatus of claim 17, wherein:
the sensory input is configured to communicate information related to an environment external to the robotic platform;
the first portion comprises a first sensory spike;
the reinforcement signal comprises reinforcement spike;
the output comprises an output spike; and
the efficacy determination is effectuated responsive to an occurrence of a second sensory spike of the sensory input subsequent to the reinforcement spike.

20. A spiking neuron network apparatus, comprising:
one or more processors configured to execute computer program modules to cause one or more processors to:
operate a first unit of the network in accordance with a first process;
operate a first connection in accordance with a second process, the first connection being configured to provide a spiking input into the first unit;
operate one or more second connections in accordance with a third process, the one or more second connections being configured to communicate a spike from the first unit;
based on an event associated with the spike, execute:
a first update of the first process; and
one or more of second updates of the third process associated with individual ones of the one or more second connections;
wherein individual ones of the one or more of second updates of the second process are configured based on one or more parameters associated with the third process.

21. The network apparatus of claim 20, wherein:
the first update of the first process is configured based on one or more outcomes of the one or more of second updates; and
the third process is configured to communicate the one or more parameters to the second process using a payload associated with the spiking input, the payload being characterized by a plurality of bits.

22. The network apparatus of claim 20, wherein:
the first update of the first process is configured based on one or more outcomes of the one or more of second updates; and
the first update of the first process is configured to occur subsequent to determination of individual ones of the one or more outcomes.

23. The network apparatus of claim 20, wherein the execution of the computer program modules is further configured to cause one or more processors to:
operate a second unit of the network in accordance with the first process, the second unit being configured to cause the provision of the spiking input into the first unit via the first connection.

24. The network apparatus of claim 23, wherein:
the operation of the second unit in accordance with the first process is configured to cause a third update of the second process associated with the first connection;
wherein individual ones of the one or more of second updates of the second process are configured based on one or more parameters associated with the third process.

25. The network apparatus of claim 23, wherein the execution of the computer program modules is further configured to cause one or more processors to:
maintain a state of the third process responsive to the event.

26. The network apparatus of claim 25, wherein:
the one or more second connections comprise a plurality of second connections configured to communicate the spike to a plurality of third units;
individual ones of the plurality of second connections are characterized by a plurality third unit identification numbers;
the first process is configured to access memory associated with individual ones of the plurality of second connections in accordance with a respective identification number; and
individual ones of the plurality of third unit identification numbers are arranged in a sorted array.

27. The network apparatus of claim 26, wherein:
the one or more second connections comprise a plurality of second connections configured to communicate the spike to a plurality of third units; and
individual ones of the plurality of second connections are characterized by a plurality third unit identification numbers.
